(19) United States
(12) Patent Application Publication
(10) Pub. No.: US 2008/0019847 A1
(43) Pub. Date: Jan. 24, 2008

(54) WAVE ENERGY CONVERTER

(75) Inventors: Alan Robert Burns, Nedlands (AU); Petru Tinc, Ocean Reef (AU)

Correspondence Address: MERCHANT & GOULD PC, P.O. BOX 2903, MINNEAPOLIS, MN, 55402-0903, US

(73) Assignee: Seapower Pacific Pty. Ltd., West Perth (AU)

(21) Appl. No.: 11/836,631

(22) Filed: Aug. 9, 2007

Related U.S. Application Data
(63) Continuation of application No. 10/519,324, filed on Aug. 4, 2005, now abandoned.

(30) Foreign Application Priority Data
Jun. 27, 2002 (AU) PS3247
Dec. 23, 2002 (AU) 20029533559

(51) Int. Cl. F03B 13/18; F04B 17/00

(52) U.S. Cl. 417/330

(57) ABSTRACT

Apparatus (10) for capturing wave energy in a body of water such as the sea. The apparatus (10) rests on the seabed and comprises a body structure (11) having a portion such as a flexible diaphragm (19) adapted to deflect in response to wave action. Pumps (51), each defining a pumping chamber (55), are adapted to undergo expansion and contraction in response to deflection of the portion of the body structure. Each pumping chamber (55) has an inlet (61) communicating with the seawater and an outlet (62), whereby seawater is drawn into the pumping chamber upon volume expansion thereof from the pumping chamber and is discharged through the outlet upon volume reduction thereof through the outlet. The diaphragm (19) typically comprises a substantially rigid portion (21) and a flexible portion (23), with the pumps (51) operably connected to the rigid portion. There may be a plurality of said rigid portions (21) adapted for articulation one with respect to another to define an articulated structure. Where there are a plurality of rigid portions, they may be disposed in a concatenate relationship extending in the direction of wave travel.

This application is a Continuation of application Ser. No. 10/519,324, filed 4 Aug. 2005, and which application(s) are incorporated herein by reference.

### FIELD OF THE INVENTION

This invention relates to apparatus for converting wave energy into a form which can perform useful work.

The invention has been devised particularly, although not necessarily solely, for harnessing ocean wave energy and converting the harnessed energy to pressurised seawater for use in any appropriate way. For example, the seawater under high pressure may be piped to shore and fed to a reverse osmosis desalination unit to yield fresh water. The salt water concentrate exiting the desalination unit, which is still at high pressure, may be fed to a turbine and the shaft power used to generate electricity.

### BACKGROUND ART

There have been many proposals for devices that seek to harness ocean wave energy but only a few of such devices are actually under sustained commercial development. All of the commercial devices, whether shore based, ashore or offshore, have their energy conversion to electricity with the necessary equipment located in situ. This means the critical components such as turbines, alternator/generators and electrical distribution infrastructure must be able to withstand the marine environment including such factors as: the force of storms, prolonged exposure to seawater, and accidental immersion in seawater. In the case of offshore devices, there is also the need for extensive undersea power cabling to bring electricity to shore. The net result is increased capital cost and decreased reliability.

It is against this background, and the problems and deficiencies associated therewith, that the present invention has been developed.

### DISCLOSURE OF THE INVENTION

According to one aspect of the invention there is provided apparatus for capturing wave energy in a body of water, the apparatus comprising a body structure having a portion thereof adapted to deflect in response to wave action, a pump defining a pumping chamber adapted to undergo expansion and contraction in response to deflection of the portion of the body structure, the pumping chamber having an inlet communicating with a fluid source and an outlet, whereby fluid from the fluid source is drawn into the pumping chamber upon volume expansion thereof from the pumping chamber and is discharged through the outlet upon volume reduction thereof through the outlet.

Typically the body of water is the ocean, in which case the water is seawater.

Preferably, said fluid source comprises water from the body of water.

The portion of the body structure adapted to deflect in response to wave action may comprise a flexible diaphragm exposed to a body of water incorporating wave action.

The diaphragm may comprise a substantially rigid portion and a flexible portion. Preferably, the flexible portion surrounds the rigid portion. The pump may be operably connected to the rigid portion.

The flexible portion may comprise a flexible membrane on which the rigid portion is mounted. There may be a plurality of said rigid portions adapted for articulation one with respect to another to define an articulated structure. Where there are a plurality of rigid portions, they may be disposed in a concatenate relationship extending in the direction of wave travel. The rigid portions may be spaced apart in the concatenate relationship to permit angular movement therebetween. Preferably, the rigid portions are mounted on the flexible portion, whereby the flexible portion provides a connection between adjacent rigid portions.

Preferably, each rigid portion has a respective pump operably connected thereto. The body structure may comprise a hollow structure having an upper end closed by the diaphragm. Typically, the outer periphery of the diaphragm is sealingly connected to a peripheral wall of the hollow structure.

The body structure may include a chamber which is disposed below the flexible diaphragm and which is adapted to contain a compressible fluid such as air. In one arrangement, the chamber undergoes volume expansion and volume reduction upon deflection of the diaphragm, with the compressible fluid contained within the fluid chamber being progressively compressed to yieldingly resist movement of the diaphragm in an inward direction corresponding to volume reduction of the chamber in response to wave pressure and to urge the diaphragm in the opposite direction upon abatement of the wave pressure.

In another arrangement, the volume of the chamber remains generally constant, the compressible fluid in the chamber being re-distributed within the chamber in response to deflection of the diaphragm without a substantial change in the volume and pressure thereof.

In still another arrangement, the body structure may include a plurality of chambers interconnected for fluid communication therebetween and containing a compressible fluid such as air, the chambers being disposed in a series substantially aligned with the direction of wave travel, each chamber being disposed beneath a respective flexible diaphragm, the arrangement being that the diaphragms deflect in sequence in response to wave activity, with the fluid being re-distributed within the chambers to exert a restoring force on the diaphragms.

A valve system may be associated with the inlet and outlet of the or each pumping chamber. Preferably, the valve system includes an inlet valve adapted to open upon volume expansion of the pumping chamber and adapted to close upon volume reduction of the pumping chamber. Preferably, the valve system further includes an outlet valve associated with the outlet, the outlet valve being adapted to close upon volume expansion of the pumping chamber and to open during volume reduction only after fluid contained within the pumping chamber thereof attains a prescribed pressure. In this way, fluid is discharged from the pumping chamber is at a higher pressure than the intake pressure.

Means may be provided to selectively block operation of any one or more of the pumping chambers. With this arrangement, the diaphragm can be caused to deflect in pivotal fashion in response to wave action, with the blocked pumping chamber or chambers providing the fulcrum about which the diaphragm can angularly deflect or pivot. This arrangement may be advantageous in certain situations particularly where the ocean conditions are such that the wave action is small (such as in light sea conditions). The arrangement allows the diaphragm to angularly deflect or pivot in response to the limited wave action. Additionally, the diaphragm can be arranged to pivot about an axis transverse to the oncoming wave action, so enhancing the responsiveness of the diaphragm in conditions where wave action is limited.

The pumping chambers can be blocked in any appropriate way such as by simply closing the outlet valves thereof, or introducing an incompressible fluid into the first chamber.

The pumping chamber may have an elastomeric wall adapted to undergo extension and contraction corresponding to a volume change of the pumping chamber.

In one arrangement, the pump may comprise a bellows structure constructed at least in part of elastomeric material. The bellows structure may be configured as a bellows column supporting the diaphragm.

The elastomeric material of said bellows structure defines said elastomeric wall of the pumping chamber. The elastomeric wall undergoes expansion and contraction as the bellows expands and contracts, expansion of the elastomeric wall corresponding to a volume expansion of the pumping chamber, and contraction of said wall corresponding to a volume reduction of the pumping chamber.

The bellows structure may, for example, comprise a plurality of annular discs formed of elastomeric material, the annular discs being assembled in side-by-side relationship concentrically on a common axis, the annular discs (apart from the two endmost discs) each being formed integrally with or connected to an adjacent disc on one side thereof at the radially inner ends thereof and being formed integrally with or connected to an adjacent disc on the other side thereof at the radially outer ends thereof.

In another arrangement the elastomeric wall may comprise an elastomeric sheath cooperating with a piston, whereby reciprocating movement of the piston causes expansion and contraction of the elastomeric sheath, expansion of the elastomeric sheath corresponding to a volume reduction of the pumping chamber and contraction of the elastomeric sheath corresponding to a volume expansion of the pumping chamber.

Preferably, the elastomeric sheath is supported on a wall of a hollow housing, whereby the elastomeric sheath is accommodated within the interior of the hollow housing and wherein the pumping chamber is defined between the elastomeric sheath and the hollow housing. Typically, the piston extends through said wall of the hollow housing such that the elastomeric sheath is received thereon. With this arrangement, reciprocatory motion of the piston causes expansion and contraction of the elastomeric sheath.

Preferably, water entering the or each pumping chamber is filtered. The water may be filtered by way of a sand filtration system. The sand filtration system may comprise a body of sand contained in a second chamber within the body structure. The second chamber may communicate with the body of water in which the apparatus is immersed by way of one or more flow paths.

The body structure may further include a third chamber defining a reservoir for receiving filtered water from the second chamber. Filtered water can be extracted from the reservoir for delivery to the pumping chambers.

Preferably, means are provided for selectively displacing said portion to compensate for tidal conditions. Such means may comprise an adjustable support arrangement for the bellows columns, whereby the bellows columns can be selectively raised or lowered in unison to adjust the vertical position of the diaphragm.

A stabilisation means may be provided for laterally stabilising each bellows structure. The stabilisation means may comprise a system of bracing cables connected to the bellows structure. Where there are three bellows structures, each bellows structure may be connected to each other bellows structure by way of a cable. Additionally, each bellows structure is connected to a wall structure surrounding the bellows structure by two further cables. With this arrangement, the cables extending between the three bellows structures are in a delta configuration. Furthermore the two cables extending from each bellows structure to the surrounding wall are each respectively aligned with one side of the delta configuration.

A damper means may be provided for progressively damping inward excursions of the diaphragm in heavy sea conditions. The damper means may comprise a damping bellows having a buffer surface against which the diaphragm can act upon inward deflection thereof. The buffer surface is defined at one end of the damping bellows which can expand and contract in order to move the buffer surface. The damping bellows defines a damping chamber containing a damping fluid such as water. The damping chamber communicates with a reservoir by way of a flow path which incorporates flow impedance, such that there is resistance of flow from the damping chamber as the latter undergoes volume reduction in response to forces imparted to the buffer surface through contact by the diaphragm. With this arrangement, the damping bellows limits the extent of inward excursion of the diaphragm but the permitted amount of the excursion progressively increases as the wave action increases. Once the sea conditions have abated and the diaphragm no longer contacts the buffer surface, the damping diaphragm can be returned to its normal condition upon expansion of the damping chamber. A spring means may be provided for biasing the damping diaphragm towards the normal condition and thereby progressively expanding the volume of the damping chamber. The volume of the damping chamber expands at a controlled rate governed by the rate at which the damping fluid can return to the damping chamber, the rate of return flow also being subject to flow impedance.

The apparatus may further comprise a holding chamber adapted to undergo volume expansion and contraction in response to deflection of said portion, the holding chamber being in fluid communication with the body of water to receive water therefrom upon volume expansion of the holding chamber, the inlet of the pumping chamber communicating with the holding chamber to receive water therefrom, whereby water from the holding chamber is drawn into the pumping chamber upon volume expansion thereof and is discharged through the outlet in a pressurised condition upon volume reduction of the pumping chamber, and means for applying a selectively adjustable restoring force to said portion for biasing the holding chamber into a condition corresponding to volume expansion thereof.

With this arrangement, a degree of resonant energy extraction from wave action can be achieved with apparatus that is physically smaller than a half wavelength of the wave. Energy can be extracted in resonance with the wave action by virtue of the selectively adjustable restoring force.

This arrangement thus provides a mechanically resonant system, making it fundamentally easier to extract energy from wave action and also to apply well-known frequency and phase shifting techniques to adapt the response of the apparatus to a range of wave periods.

The means for applying a restoring force may comprise a volume of gaseous fluid adapted to undergo compression upon volume reduction of the holding chamber. This thus provides a gas spring.

The volume of gaseous fluid may be confined in a zone comprising an upper region within the holding chamber above the volume of water contained therein. The zone may further comprise an auxiliary chamber of substantially constant volume in communication with the upper region of the holding chamber for gaseous fluid flow therebetween.

Means may be provided for supplying the zone with a charge of gaseous fluid and also for selectively varying the volume of the charge. The ability to vary the volume of the gaseous fluid charge provides a mechanism for selectively adjusting the spring force generated by the gaseous fluid as it undergoes compression.

Preferably, the gaseous fluid is air. Conveniently, the air is atmospheric air supplied by way of an air supply line extending to either a location above the body of water or a shore-based facility.

In this arrangement, the portion of the body structure adapted to deflect in response to wave action preferably comprises a plunger exposed to the body of water incorporating wave action. The plunger may comprise a substantially rigid plate exposed to hydrodynamic forces generated by wave action.

The body structure may comprise an upper and lower portions arranged telescopically with respect to each other, with the lower portion being fixed with respect to the floor of the body of water and the upper portion being movable with respect to the lower portion in response to wave action.

The holding chamber may be defined within the upper and lower portions, and the pumping chamber may be disposed between the upper and lower portions.

The upper and lower portions may define a gap therebetween through which water from the body of water in which the apparatus is immersed can flow to enter the holding chamber as previously described.

Where the pumping chamber is defined by a bellows structure, one end of the bellows structure may be connected to the upper portion of the body and the other end of the bellows structure may be connected to the lower portion of the body. Preferably, there are a plurality of the pumping chambers.

According to a second aspect of the invention there is provided apparatus for capturing wave energy in a body of water, the apparatus comprising a body structure having a portion thereof adapted to move in response to wave action, a pump defining a pumping chamber adapted to undergo volume expansion and volume reduction in response to movement of the portion of the body structure, the pumping chamber having an inlet communicating with a fluid source and an outlet whereby fluid from the fluid source is drawn into the pumping chamber upon volume expansion thereof through the inlet and discharged from the pumping chamber upon volume contraction thereof through the outlet, the pumping chamber being operatively connected said portion, the pumping chamber having an elastomeric wall adapted to undergo extension and contraction corresponding to a volume change of the pumping chamber.

According to a third aspect of the invention there is provided apparatus for capturing wave energy in a body of water, the apparatus comprising a body structure having a portion thereof adapted to deflect in response to wave action, a holding chamber adapted to undergo volume expansion and contraction in response to deflection of said portion, the holding chamber being in fluid communication with the body of water to receive water therefrom upon volume expansion of the holding chamber, a pumping chamber adapted to undergo expansion and contraction in response to deflection of the portion of the body structure, the pumping chamber having an inlet communicating with the holding chamber to receive water therefrom and an outlet, whereby water from the holding chamber is drawn into the pumping chamber upon volume expansion thereof and is discharged through the outlet in a pressurised condition upon volume reduction of the pumping chamber, and means for applying a selectively adjustable restoring force to said portion for biasing the holding chamber into a condition corresponding to volume expansion thereof.

According to a still further aspect of the invention there is provided apparatus for capturing wave energy in a body of water, the apparatus comprising a body structure having a flexible diaphragm adapted to deflect in response to wave action, a pump defining a pumping chamber adapted to undergo expansion and contraction in response to deflection of the portion of the body structure, the flexible diaphragm comprising a flexible portion and a rigid portion, the pump being operably connected to the rigid portion.

### BRIEF DESCRIPTION OF THE DRAWINGS

The invention will be better understood by reference to the following description of several specifics embodiment thereof as shown in the accompanying drawings in which:

FIG. 1 is a schematic perspective view of an apparatus for capturing wave energy according to a first embodiment;

FIG. 2 is a sectional view of the apparatus of FIG. 1 showing some internal details;

FIG. 3 is a view similar to FIG. 2 showing other internal details;

FIG. 4 is also a view similar to FIG. 2 but showing the details of FIGS. 2 and 3 in combination;

FIG. 5 is a fragmentary view showing part of a seawater pumping circuit incorporated in the apparatus;

FIG. 6 is a schematic elevational view illustrating part of the seawater pumping circuit;

FIG. 7 is also a schematic elevational view illustrating part of the seawater pumping circuit;

FIG. 8 is a fragmentary view of part of the seawater pumping circuit showing the valve system, with the inlet valve thereof open;

FIG. 9 is a view similar to FIG. 8 with the exception that the inlet valve is closed;

FIG. 10 is a schematic plan view illustrating a cable stabilisation system for providing lateral support to bellows structure defining the pumping chambers;

FIG. 11 is a fragmentary underside perspective view illustrating in particular the cable support system;

FIG. 12 is also a fragmentary underside perspective view illustrating part of the cable support system;

FIG. 13 is a schematic sectional elevational view of a damper means employed in the apparatus.

FIG. 14 is a schematic cross-sectional view of an apparatus for capturing wave energy according to a second embodiment, the apparatus being illustrated in a state corresponding to the passing of a wave trough over it;

FIG. 15 is a view similar to FIG. 14 except that the apparatus is illustrated in a state corresponding to the passing of a wave peak over it;

FIG. 16 is a cross-sectional view of the apparatus in the same state as depicted in FIG. 15, with arrows indicating the direction of airflow within the apparatus;

FIG. 17 is a cross-sectional-view of the apparatus in the same state as depicted in FIG. 14, with arrows indicating the direction of airflow within the apparatus and also the direction of seawater flow;

FIG. 18 is a detailed cross-sectional view of the apparatus, illustrating in particular the disposition of vertical guiding runners, with arrows indicating the direction of seawater flow;

FIG. 19 is a top view of the apparatus, illustrating in particular the angular disposition of the guiding runners;

FIG. 20 is a detailed cross-sectional view of the apparatus, illustrating an air pump utilized therein;

FIG. 21 is a detailed cross-sectional view, illustrating a water pump utilized therein;

FIG. 22 is a detailed cross-sectional view of the apparatus, illustrating the disposition of a bellows pumping chamber and related components utilized therein, with arrows indicating the direction of seawater flow.

FIG. 23 is a detailed cross-sectional view of the apparatus, illustrating a sealing means utilized therein;

FIG. 24 is a detailed cross-sectional view of the apparatus, illustrating the disposition of a manifold, low pressure feed line and high pressure line, with arrows indicating the direction of seawater flow;

FIGS. 25 and 26 are detailed cross-sectional views of the manifold;

FIG. 27 is a cross-sectional view of a apparatus for capturing wave energy according to a third embodiment, the apparatus being illustrated in a state corresponding to the passing of a wave trough over it;

FIG. 28 is a view similar to FIG. 27 except that the apparatus is illustrated in a state corresponding to the passing of a wave peak over it;

FIGS. 29 and 30 are detailed cross-sectional views of apparatus of the third embodiment illustrating the disposition of a dual manifold, bellows pumping chamber, support frame and connecting strut;

FIG. 31 is a detailed cross-sectional view of the inner workings of the dual manifold of the apparatus of the third embodiment, with arrows indicating the direction of high pressure and low-pressure seawater flow;

FIG. 32 is a close up view of one of valve elements of the dual manifold of FIG. 31 and, in particular, the two positions of the flap valve;

FIG. 33 is a cross-sectional view of a apparatus for capturing wave energy according to a fourth embodiment, the apparatus being illustrated in a state corresponding to the passing of a wave trough over it;

FIG. 34 is a view similar to FIG. 33 except that the apparatus is illustrated in a state corresponding to the passing of a wave peak over it;

FIG. 35 is a detailed cross-sectional view of apparatus according to the fourth embodiment, illustrating the disposition of the upper and lower support frames relative to the bellows pumping chamber and manifolds therefor;

FIG. 36 is a schematic cross-sectional view of an apparatus for capturing wave energy according to a fifth embodiment, the apparatus being illustrated in a state corresponding to a wave peak commencing to pass over the apparatus;

FIG. 37 is a view similar to FIG. 36, with the exception that the wave peak is shown further over the apparatus;

FIG. 38 is a view similar to FIG. 37, with the exception that the wave peak is shown further over the apparatus;

FIG. 39 is a view similar to FIG. 38, with the exception that the wave peak is in the concluding stage of its passage over the apparatus;

FIG. 40 is a sectional perspective view of the apparatus;

FIG. 41 is a partial plan view of the apparatus;

FIG. 42 is a schematic cross-sectional view of an apparatus for capturing wave energy according to a sixth embodiment;

FIG. 43 is a partial plan view of the apparatus of FIG. 42;

FIG. 44 is a schematic cross-sectional elevational view of an apparatus for capturing wave energy according to a seventh embodiment, the apparatus being illustrated in one state of operation;

FIG. 45 is a view similar to FIG. 44, with the exception that the apparatus is shown in a further state of operation;

FIG. 46 is a fragmentary elevational view of the apparatus of FIG. 44;

FIG. 47 is a further fragmentary elevational view of the apparatus, illustrating in particular the manner of mounting the flexible diaphragm in position;

FIG. 48 is a further fragmentary elevational view of the apparatus, illustrating in particular the manner of attachment between a plate and an elastic membrane which together form the flexible diaphragm;

FIG. 49 is a schematic plan view of an apparatus for capturing wave energy according to an eighth embodiment;

FIG. 50 is a schematic plan view of a wave energy conversion system utilizing an array of units each comprising an apparatus for capturing wave energy according to any one of the previous embodiments;

FIG. 51 is a schematic cross-sectional elevational view of a positive displacement pump which may be used with apparatus according to any of the previous embodiments; and

FIG. 52 is a fragmentary view of the pump of FIG. 51.

### BEST MODE(S) FOR CARRYING OUT THE INVENTION

The embodiments shown in the drawings are each directed to an apparatus for harnessing ocean wave energy and for converting the harnessed energy to high-pressure seawater. The apparatus rests on the seabed in relatively shallow waters and creates minimal environmental impact. The high-pressure seawater is piped to shore for use in any appropriate purpose. In one application, the high-pressure seawater may be used as a motive fluid to drive a turbine, with the shaft power therefrom being used to generate electricity. In another application the high-pressure seawater may be fed to a reverse osmosis desalination unit from which fresh water can be generated. The saltwater concentrate from the desalination unit, which is still at high pressure, may then be fed to a turbine for extraction of mechanical energy.

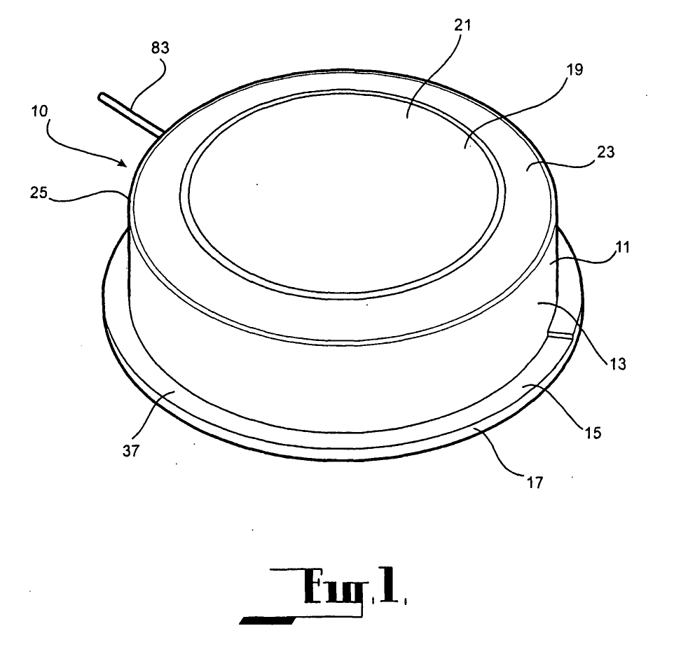

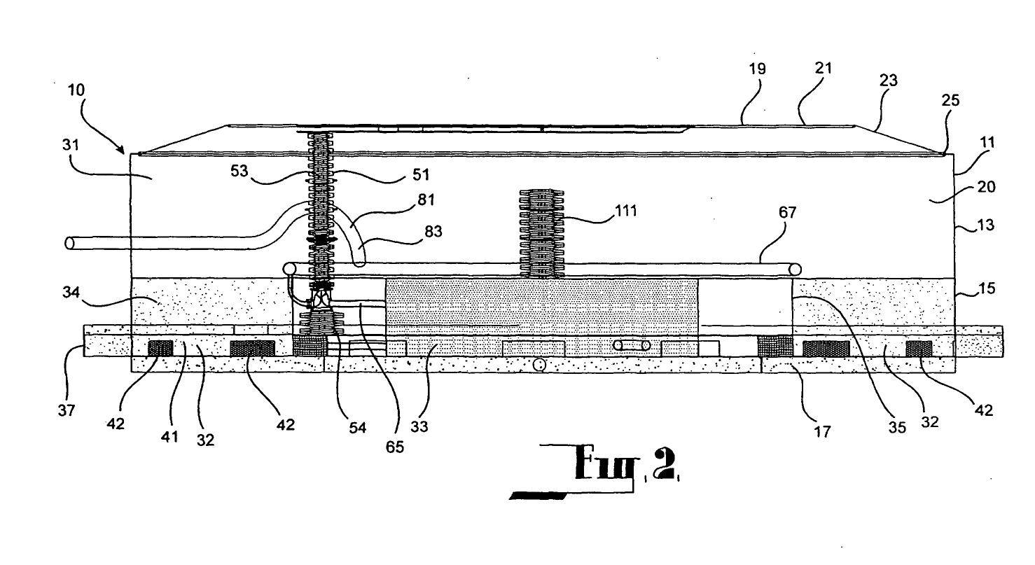

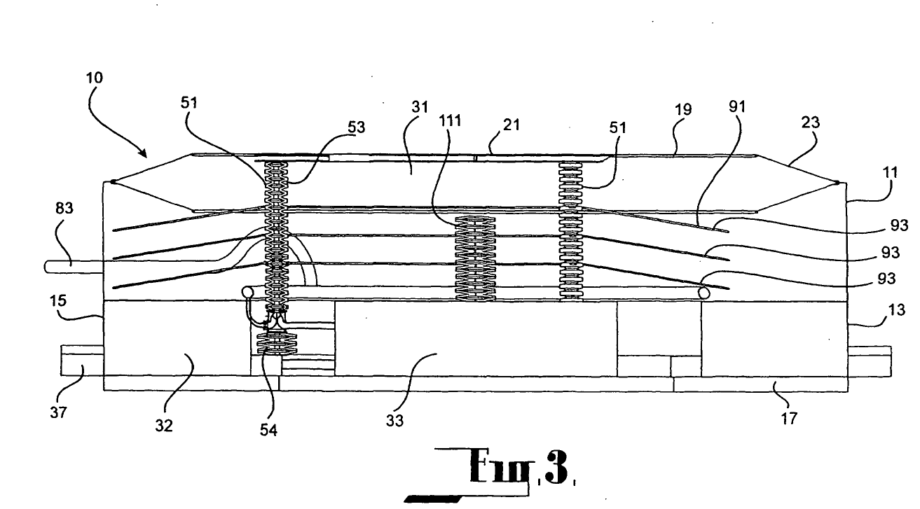

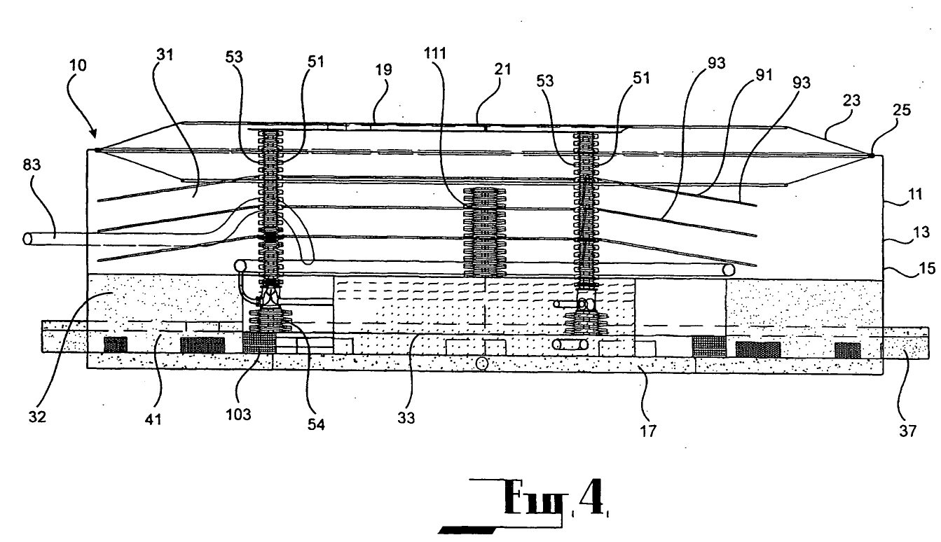

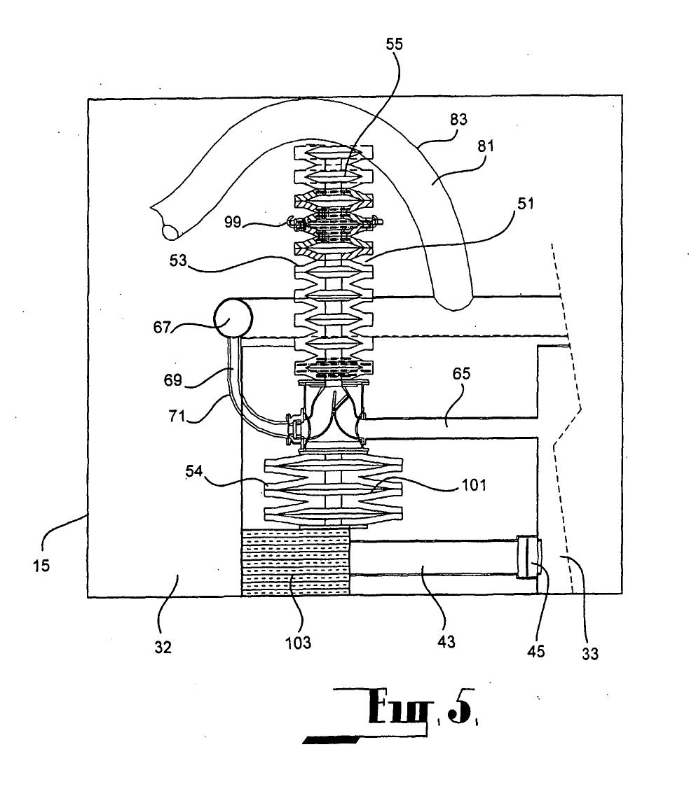

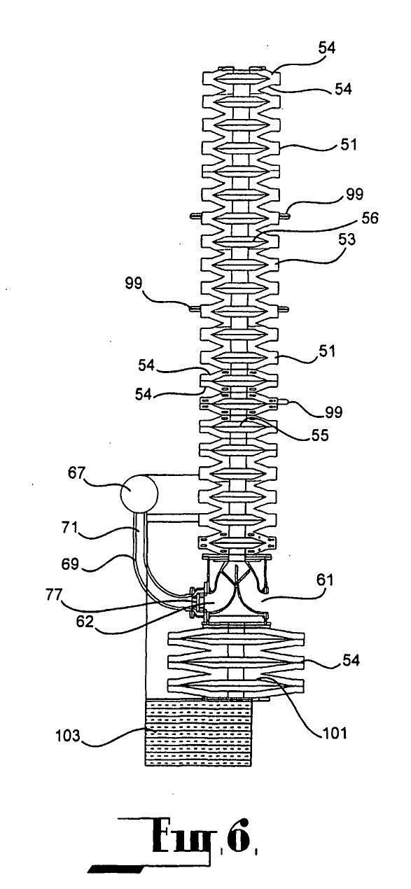

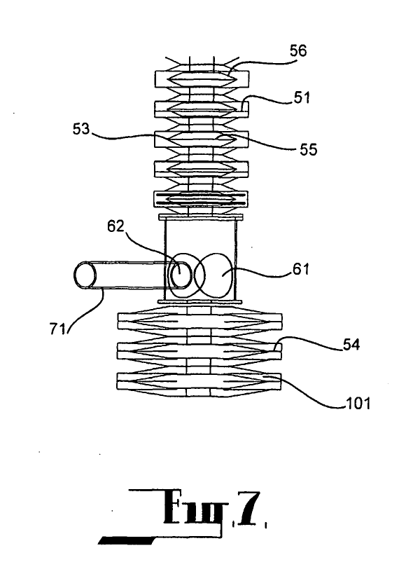

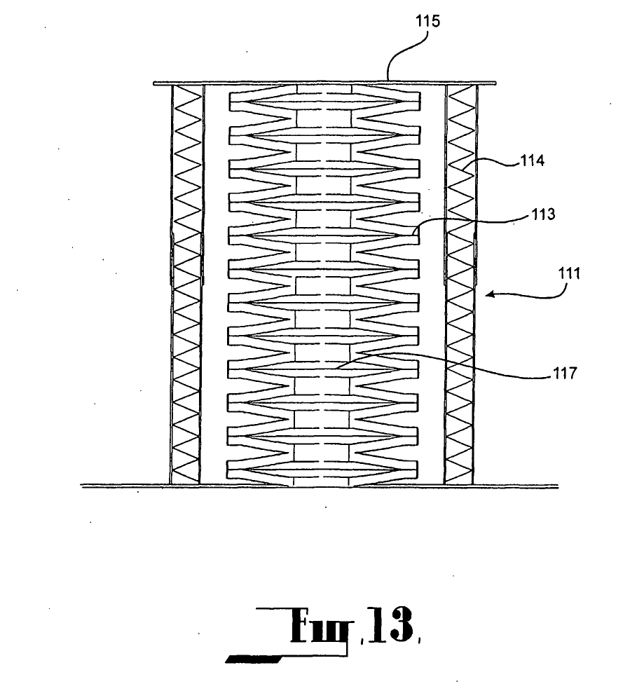

Referring to FIGS. 1 to 13, the apparatus 10 according to the first embodiment comprises a body structure 11 in the form of a squat cylinder 13 having a cylindrical sidewall 15. The bottom end of the squat cylinder 13 is closed by a base 17 which rests on the seabed. The top end of the cylinder 13 is closed by a diaphragm 19. With this arrangement, an interior space 20 is defined within the cylinder 13 between the base 17 and the diaphragm 19.

The diaphragm 19 comprises a rigid central portion 21 and a flexible outer portion 23 surrounding the central portion 21. The rigid central portion 21 is in the form of a reinforced circular plate and the outer portion 23 is formed of an elastomer such as natural rubber. The elastomer is reinforced with laminating materials to enhance strength and tear resistance. The outer periphery of the diaphragm 19 is sealingly connected at 25 to the upper end of the cylindrical side wall 15 of the cylinder 13.

The interior space 20 defines a first chamber 31 which is disposed immediately below the diaphragm 19 and which contains a compressible fluid which conveniently is air. The air is under pressure to provide a lifting force to counterbalance the weight of the diaphragm 19 and seawater above the diaphragm. The air pressure is adjusted so as to maintain the diaphragm 19 at a predetermined position in calm sea conditions. In this embodiment, the central portion 21 of the diaphragm 19 is maintained at a position above the upper edge of the cylindrical side wall 15. When exposed to fluid pressure arising from wave activity, the diaphragm 19 is forced downwardly towards the interior space 20, with the flexible outer portion 23 undergoing elastic expansion.

A duct (not shown) extends upwardly from the first chamber 31 to atmosphere for delivery of replenishment air to the chamber 31, as necessary. The upper end of the duct may be incorporated in a marker buoy floating on the ocean surface. Alternatively, the replenishment air may be supplied from a shore-based facility via a pipeline.

The interior space 20 also accommodates a second chamber 32 and a third chamber 33.

The second chamber 32 is of annular configuration and is defined between an inner annular wall 35 supported on the base 17 and the cylindrical side wall 15 of the body structure 11. The second chamber 32 is filled with sand 34 which provides ballast for the body structure 11 and which also is used for filtering purposes as will be explained later. Preferably, the sand is obtained from the seabed during installation of the apparatus 10. The second chamber 32 is of a size so that when completely filled with wet sand it counteracts the buoyancy effects of the submerged structure 11.

A peripheral portion 37 is disposed around the outer side of the cylindrical wall 15 adjacent the base 17 to receive additional sand ballast material. The peripheral portion 37 is configured as an open trough which can be filled with sand dredged from the seabed.

The sand 34 contained within the second chamber 32 is used in a sand filtration system 41 for the purpose of filtering seawater which is pumped by the apparatus 10, as will be explained later.

The third chamber 33 defines a reservoir for containing filtered seawater received from the filtration system 41. The filtration system 41 includes a plurality of ports (not shown) providing communication between the interior of the second chamber 32 and the surrounding seawater in which the body structure 11 is immersed. The ports open onto the seawater through the cylindrical side wall 15 of the body structure 11. The openings are covered with screens 42 for preventing entry of objects above a predetermined size.

Hydrostatic pressure of the surrounding seawater causes fluid flow through the ports to the interior of the second chamber 32 so as to cause the sand 34 contained therein to become saturated with seawater.

The reservoir 33 communicates with the second chamber 32 by way of flow passages defined by a plurality of radially extending pipes 43. Each pipe 43 contains a one-way valve 45 that permits flow only in the direction to the reservoir 33. The one-way valves 45 are arranged to permit flow into the reservoir 33 under the influence of the hydrostatic pressure of the seawater.

The reservoir 33 may incorporate means such as baffles for avoiding surges and like flows which might otherwise hinder settling of silt and the like contained in seawater in the reservoir.

The sand filtration system 41 may also incorporate means for reverse flushing the sand filter at periodic intervals to remove debris and regenerate the filter. Such an arrangement may involve flushing pipes (not shown) extending between the second reservoir 32 and the outer periphery of the body structure 11, with the pipes being capped or otherwise closed when not in use for reverse flushing purposes.

A plurality of positive displacement pumps 51 are operatively connected to the diaphragm 19. In this embodiment, there are three such pumps and each is in the form of a bellows structure 53 configured as a bellows column. One end of each bellows column 53 is connected to the diaphragm 19 and the other end is mounted on an adjustable support 54.

Each bellows structure 53 is formed of elastomeric material. Specifically, each bellows structure 53 comprises a plurality of annular discs 54 formed of elastomeric material. The annular discs 54 are assembled in side-by-side relationship concentrically on a common axis, the annular discs (apart from the two endmost discs) each being connected to an adjacent disc on one side thereof at the radially inner ends thereof and being connected to an adjacent disc on the other side thereof at the radially outer ends thereof.

Each bellows structure 53 is adapted to extend and contract in response to movement of the diaphragm 19. A pumping chamber 55 is formed within each bellows structure 53, with the pumping chamber 55 undergoing volume expansion upon extension of the bellows structure and volume reduction upon contraction of the bellows structure. With this arrangement, the pumping chamber 55 has an elastomeric wall 56 which extends and contracts on volume expansion and volume reduction of the pumping chamber.

Each pumping chamber 55 has an inlet 61 which communicates with the reservoir 33 thereby to receive filtered seawater therefrom upon volume expansion of the pumping chamber 55. The inlet 61 communicates with the reservoir 33 by way of an inlet path 63 defined by inlet pipe 65. The inlet pipe 65 opens onto the upper portion of the reservoir 33 so that seawater is drawn from the upper level thereof. This is to diminish the likelihood of drawing silt and other debris from the reservoir.

Each pumping chamber 55 also has an outlet 62 communicating with a ring manifold 67 by way of an outlet path 69 defined by an outlet pipe 71. The manifold 67 is common to each of the bellows structures 53 and communicates with the pumping chamber in each bellows structure by way of the respective outlet pipe 71.

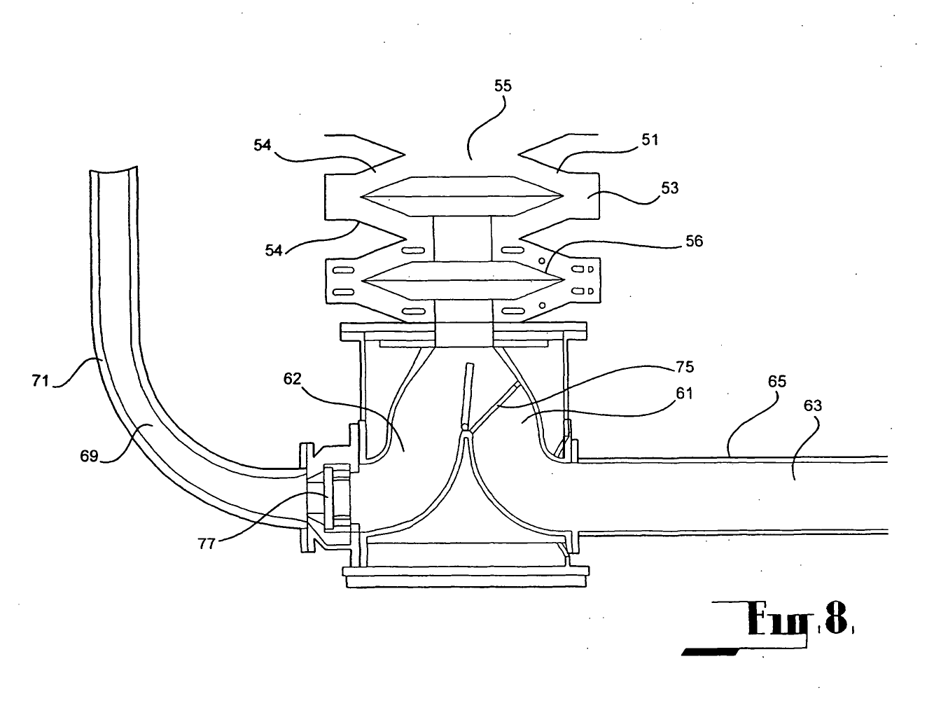

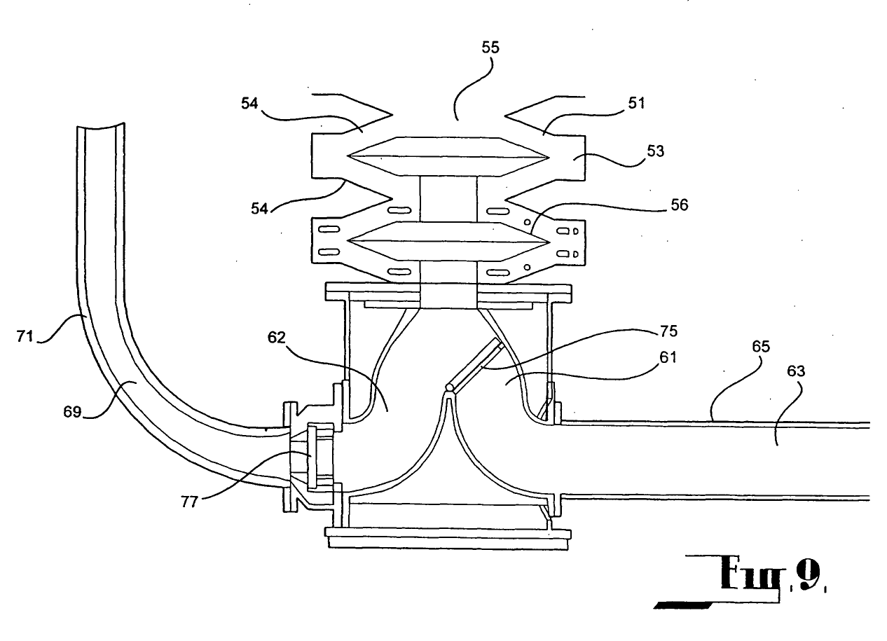

A valve system is associated with the inlet 61 and the outlet 62. The valve system comprises an inlet valve 75 associated with the inlet 61 and an outlet valve 77 associated with the outlet 62. The inlet valve 75 is adapted to open (as shown in FIG. 8) upon volume expansion of the pumping chamber 55 and is adapted to close (as shown in FIG. 9) upon volume reduction of the pumping chamber. The outlet valve 77 is adapted to close upon volume expansion of the pumping chamber 55 and to open during volume reduction but only after seawater contained within the pumping chamber has attained a prescribed pressure. With this arrangement, seawater is discharged from each pumping chamber 55 at a higher pressure than that at which it is induced into the pumping chamber.

The manifold 67 communicates with an outlet path 81 defined by outlet pipe 83. The outlet pipe 83 is flexible to accommodate height adjustment of the manifold 67, as will be explained later. The outlet pipe 83 communicates with a pipeline by means of which the high pressure seawater can be conveyed to shore.

The upper end of each bellows structure is connected to the rigid central portion 21 of the diaphragm 19. As is evident from the drawings, the area of contact between the bellows structures 53 and the diaphragm 19 is small in order to effect a large amplification of pressures transmitted from seawater acting on the diaphragm 19 to the volume of water contained within each pumping chamber 55.

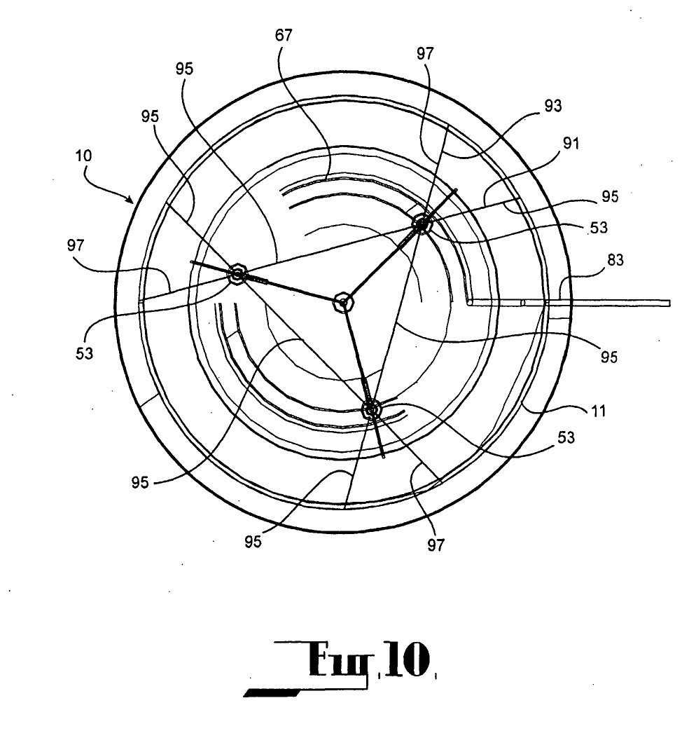

A stabilising means 91 is provided for laterally stabilising each bellows structure 53 in order to maintain substantially vertical alignment of the bellows columns. The stabilising means 91 comprises an arrangement of bracing cables 93 connected to the bellows structures 53. In particular, each bellows structure 53 is connected to each other bellows structure 53 by way of a bracing cable 95. Additionally, each bellows structure 53 is connected to the surrounding circular wall 15 by way of two further bracing cables 95, 97. With this arrangement, the cables 93 extending between the three bellows structures are in a delta configuration, as best seen in FIG. 10. Furthermore, the two cables 95, 97 extending from each bellows structure 53 to the surrounding cylindrical wall 15 are each respectively aligned with one side of the delta configuration, also as best seen in FIG. 10.

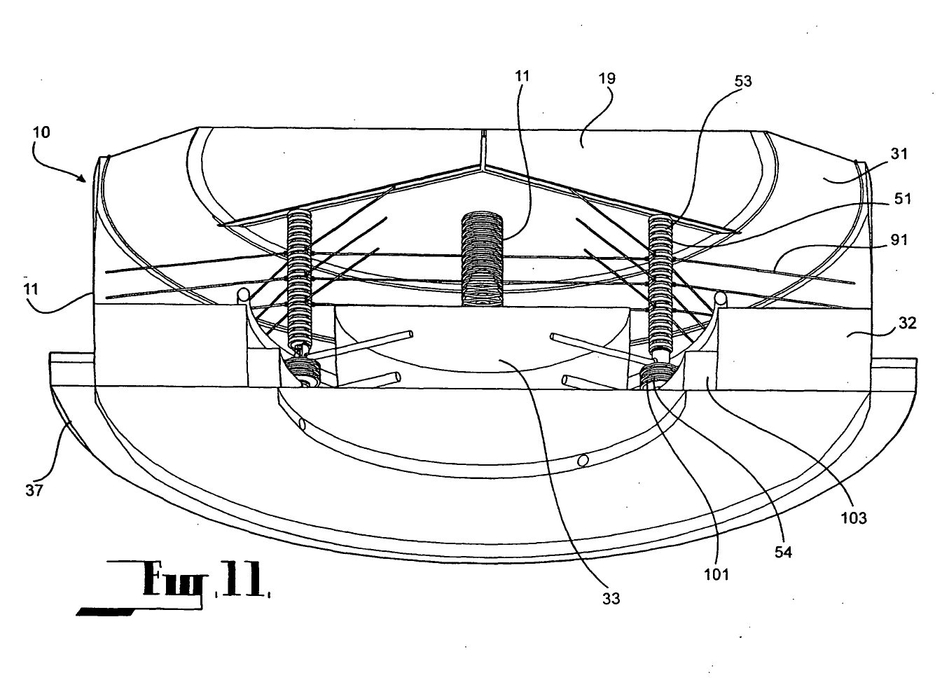

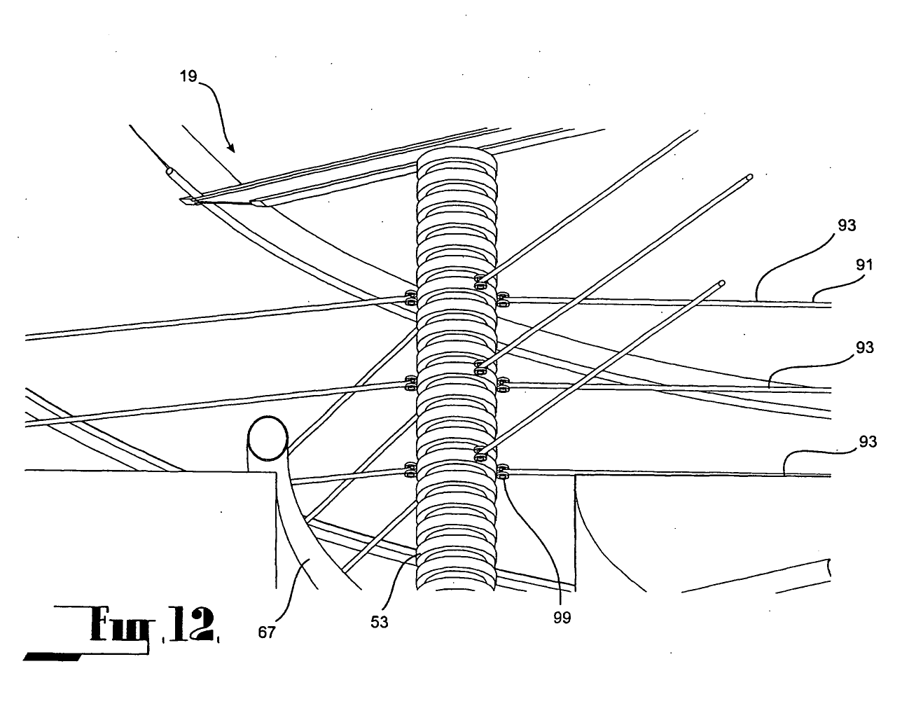

The stabilising means 91 includes a plurality of cable arrangements disposed at spaced intervals along the length of each bellows structure 53, as best seen in FIGS. 11 and 12. The cables are arranged in vertical planes in order to eliminate torsional forces.

Each cable is attached to the respective bellows column 53 at a tie point 99. The tie points 99 are in the form of hooks rigidly attached to the respective bellows section at its largest diameter.

As alluded to above, each bellows column 53 is mounted on an adjustable support 54. The adjustable support 54 comprises a height adjustment bellows structure 101 positioned between the bottom of the respective bellows structure 53 and a load bearing beam 103 disposed adjacent the inner wall 35 within the body structure 11. The load bearing beam 103 transmits load to the base 17 of the body structure 11. The various height adjustment bellows 101 are interconnected to receive a common working fluid such as seawater which operates the bellows to cause extension and contraction thereof in unison. With extension and contraction of the supporting bellows 101, it is possible to effect vertical displacement of the bellows columns 53, thereby altering the position of the rigid central portion 21 of the diaphragm 19, while maintaining it in a generally horizontal condition. In this way, the position of the diaphragm 19 can be selectively adjusted to compensate for tidal conditions. A sensor may be used to monitor the height of the main sea level above the diaphragm 19 and to effect operation of the height adjustment bellows 101 as necessary. In this way, the undeflected position of the diaphragm 19 may be held at a constant distance below sea level regardless of tidal changes. The response time of the height adjustment arrangement is made much slower than the longest period of wave motion so as not to affect the capture of wave energy yet still allow compensation for the relatively slow changes in tidal conditions. As mentioned above, the pipeline 83 is of flexible construction in order to accommodate movement of the manifold 67 with height adjustment of the bellows columns 53.

A damper means 111 is provided for progressively damping the downward excursions of the diaphragm 19 in heavy sea conditions. The damper means 111 comprises a damping bellows 113, a spring means 114, and a buffer surface 115 defined by a rigid plate against which the diaphragm can act upon inward deflection thereof. The buffer surface 115 is at one end of the damping bellows 113 which can extend and contract in order to move the buffer surface. The damping bellows 113 defines a damping chamber 117 containing a damping fluid such as seawater. The damping chamber 117 communicates with a reservoir (not shown) by way of a flow path defined by a pipe (not shown) which incorporates by-directional flow impedances. The flow impedances are such as to allow minimal damping fluid flow in each direction. With this arrangement, the damping bellows 113 limits the extent of downward excursion of the diaphragm 19 but the limited extent of each downward excursion progressively increases as the wave action increases. Once the sea conditions have abated and the diaphragm 19 no longer contacts the buffer surface 115, the damping bellows 113 can be returned to its fully extended condition under the influence of the spring means 114. As the bellows 113 returns to its fully extended condition, the volume of the damping chamber 117 expands at a controlled rate governed by the rate at which the damping fluid can return to the damping chamber, the rate of return flow also being subject to flow impedance. Generally the rate of damping fluid flow in the direction from the bellows 113 to the reservoir is made small enough that it will take many cycles of contact between the diaphragm 19 and the buffer surface 115 before the damping fluid has been substantially expelled from the damping chamber 117.

Operation of the apparatus 10 according to the embodiment will now be described. When the sea state is calm, the apparatus 10 is submerged and there is a constant head of seawater above the diaphragm 19. The diaphragm 19 is maintained at a predetermined position by appropriate air pressure within the first chamber 31 so as to balance downward forces on the diaphragm 19 arising from various factors including the weight of the diaphragm 19 and equipment attached thereto, the restoring force of the elastomeric outer portion 23 of the diaphragm 19, the restoring forces of the bellows columns 53, the hydrostatic pressure of the calm water and ambient atmospheric pressure. As a result of the large surface area of the central portion 21 of the diaphragm 19, the absolute pressure of air need only be slightly above atmospheric pressure, typically only a few psi above nominal atmospheric pressure.

At this stage, the bellows columns 53 are substantially in the extended state and the pumping chambers 55 are filled with filtered seawater drawn from the reservoir 33. Additionally, the damping bellows 113 is also in its fully extended condition under the influence of the spring means 114, and is filled with seawater.

The passage of a small wave over the apparatus 10 causes a time varying force to be exerted on the diaphragm 19, so causing the latter to move downwardly in response to this increasing force. The large amplification of pressures afforded to the bellows columns 53 causes them to contract, closing the inlet valve 75 of each bellows column and soon thereafter causing the high pressure outlet valve 77 to open. At this stage, the maximum stroke of each bellows column 53 will occur as seawater is expelled out of the pumping chamber 55 under pressure.

The downward deflection of the diaphragm 19 causes a reduction in the volume of air contained within the first chamber 31 and a corresponding increase in the pressure of the air. The air pressure continues to rise as the diaphragm 19 is deflected until an equilibrium condition is established between the force applied by the passing wave on the diaphragm 19 and the sum of the reaction forces exerted on the diaphragm 19 by the air pressure rise and the net restoring forces of the bellows columns 53 and the elastomer outer portion 23 of the diaphragm 19. At this point, the diaphragm 19 will momentarily come to rest at its maximum deflection and the contraction stroke of each bellows column 53 will conclude. Thereafter, the pressure on the diaphragm 19 will be unbalanced, so causing the diaphragm to reverse its motion as the force due to the air pressure is reasserted. Meanwhile, the head of water diminishes as the wave passes over the apparatus 10. The cessation of each bellows contraction causes the outlet valve 77 to close and so isolates the outlet pipe 71 from the pumping chamber 55. The expansion of each bellows columns 53 cause the inlet valve 75 to open so admitting seawater into the pumping chamber 55 from the reservoir 33. The diaphragm 19 and the bellows columns 53 return to their equilibrium position awaiting the next wave.

The dynamic response of the apparatus 10 may be adjusted over a wide range through judicious manipulation of key parameters including the total mass of the diaphragm 19 and attached equipment, the total air volume and air pressure within the first chamber 31, the displacement between the diaphragm 19 and the damping bellows 113, the pressure amplification factor between the diaphragm 19 and the bellows columns 53, the stroke volume of the bellows columns 53, the mechanical spring constant of the bellows columns 53 and the pressure set points for operation of the outlet valves 77.

During normal operation, variations in the tidal conditions may be compensated for by the height adjustment bellows and related systems as previously described.

As the wave height increases, there is increasing downward movement of the diaphragm 19 during each wave cycle and so as a progressive reduction in the clearance between the underside of the diaphragm 19 and the buffer surface 115 on the damping bellows 113. Eventually, the underside of the diaphragm 19 will contact the buffer surface 115 and exert a force on the damping bellows 113 causing it to contract. Since the damping bellows 113 is filled with damping fluid (seawater), it resists the force to an extent allowed by the compression of the spring means 114 as well as by the flow impedances controlling the rate at which can be discharged from the damping chamber 117. The flow impedances are set to allow a gradual retardation of the excursions of the diaphragm 19 with increasing wave motion. With each contact between the diaphragm 19 and the buffer surface 115, the damping bellows 113 is further contracted and additional damping fluid discharged from the damping chamber 117. In this way, progressively increasing excursions of the diaphragm 19 are allowed but in a controlled manner with deflections and stresses held to safe limits.

If necessary, additional damping may be obtained in high sea states by the temporary addition of supplementary air into the first chamber 31 for the duration of the adverse sea conditions.

As the sea state abates, the excursions of the diaphragm 19 will decrease and the diaphragm 19 will no longer contact the buffer surface 115. This will allow the damping bellows 113 to expand under the influence of the restoring force of the spring means 114. The direction of flow of damping fluid reverses and damping fluid slowly bleeds back through the flow impedance into the damping chamber 117 as the volume thereof expands. The bellows expansion thus follows the excursions of the diaphragm 19 until such time as the damping bellows 113 is returned to its fully extended condition.

During low sea states, it may be advantageous to optimise the extraction of wave energy by making the response of the apparatus 10 favour a particular direction if the wave energy is coming predominantly from that direction. Selectively throttling one or more of the high pressure outlets 62 may achieve this purpose. For example, in the case of the present embodiment where there are three bellows columns 53, if an approaching wave front is generally parallel to the base of a triangle formed by the three bellows columns, the two bellows columns 53 representing the base of the triangle could be blocked against operation and the remaining bellows only allowed to operate. This would then allow the diaphragm 19 to tilt in a pivotal action in the direction of the oncoming wave action, so enhancing the responsiveness of the diaphragm 19 in conditions of low seas.

Maintenance of the apparatus 10 may require access to the first chamber 31. An air lock (not shown) may be used for such purpose. Maintenance will also require that the apparatus 10 be deactivated. This can be achieved by blocking all bellows columns 53 by isolating them from the high pressure and low pressure lines when the pumping chambers 55 are full of seawater.

Rupture of the diaphragm 19 poses no damage to components inside the apparatus, as all materials are chosen to have high resistance to seawater. This is also aided by the absence of any electricity generation or distribution equipment as all such equipment is based on shore. In the event of a diaphragm rupture, divers may repair the diaphragm insitu using common adhesives and patches. An auxiliary barge may be required to facilitate the pumping out of the seawater and reinflation of the first chamber 31. Additionally, rupture of the high pressure line to shore poses no environmental hazard. The line may be covered for protection. In the event of mishap, the apparatus will automatically be shut down if loss of pressure is detected.

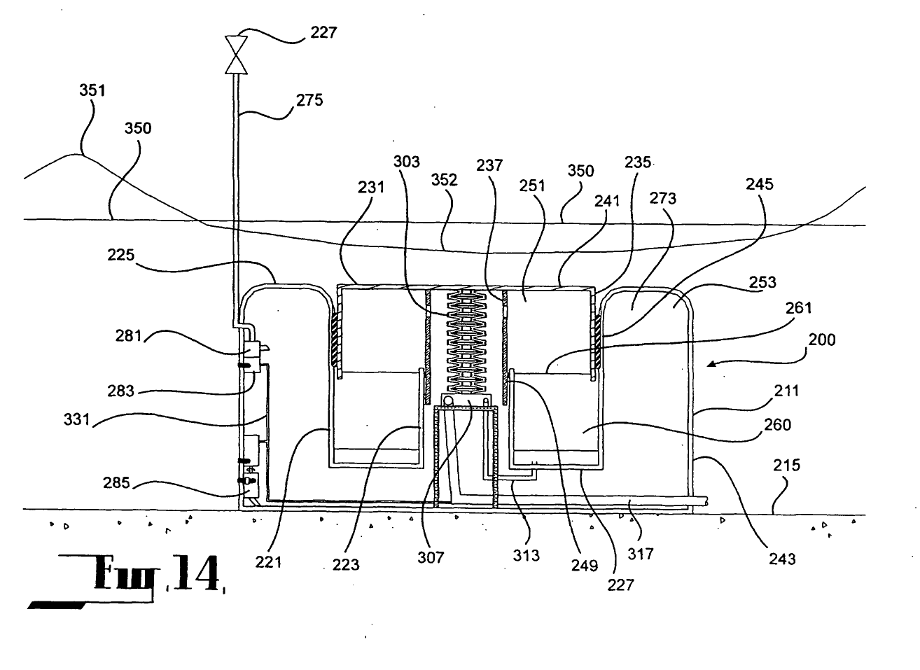

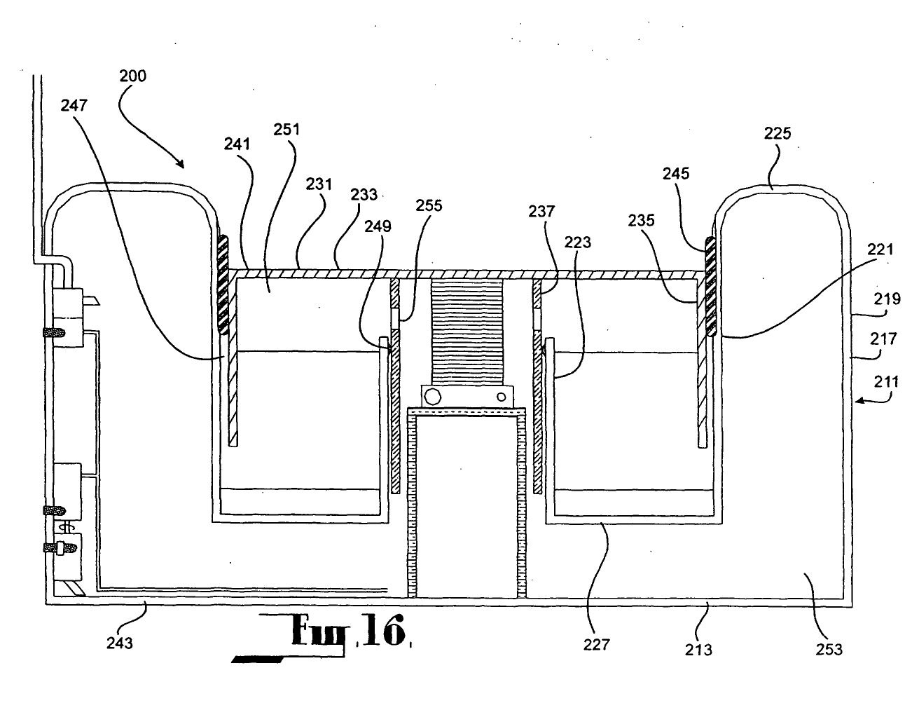

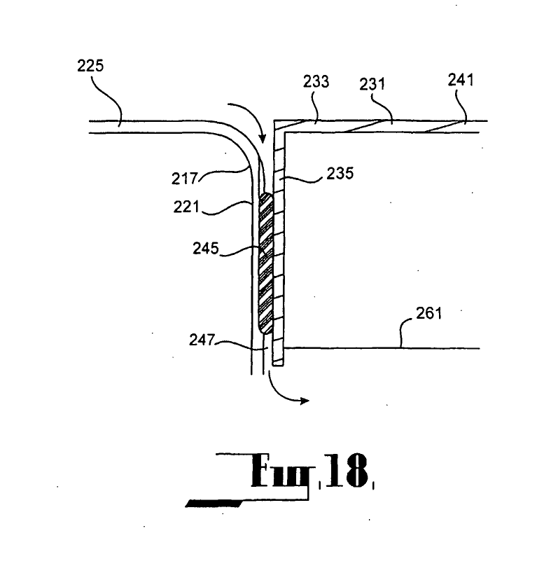

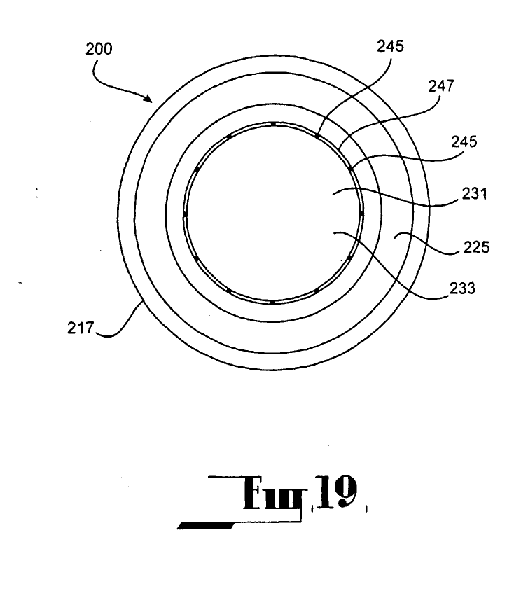

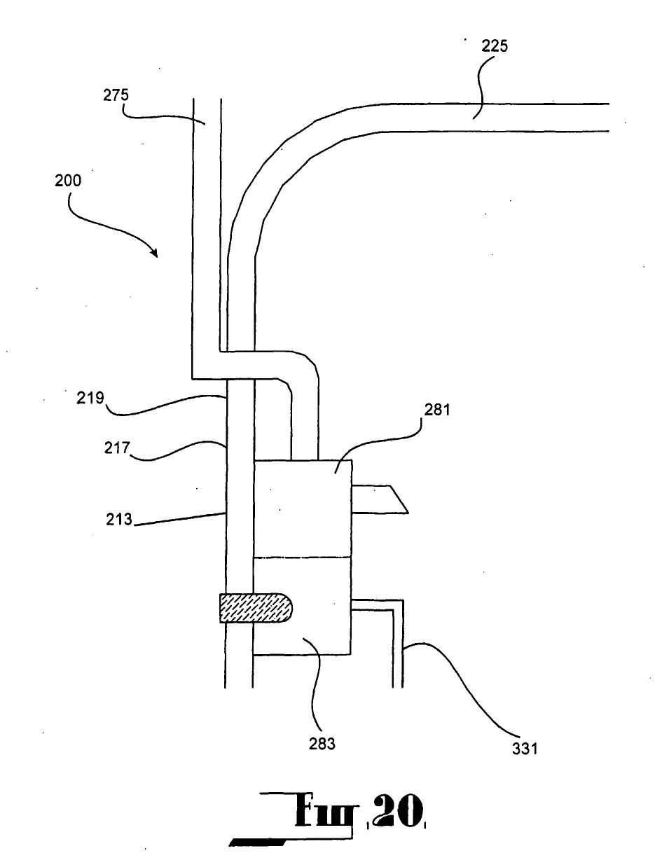

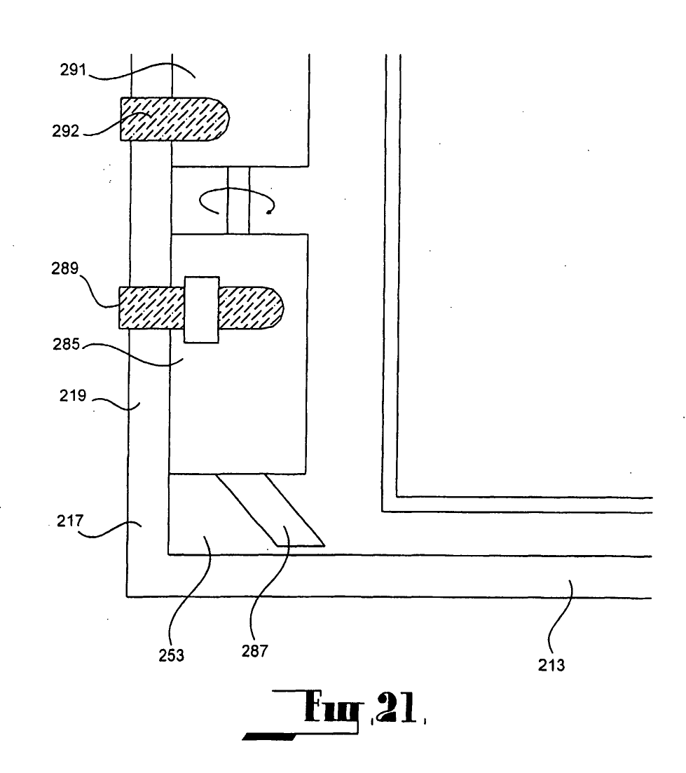

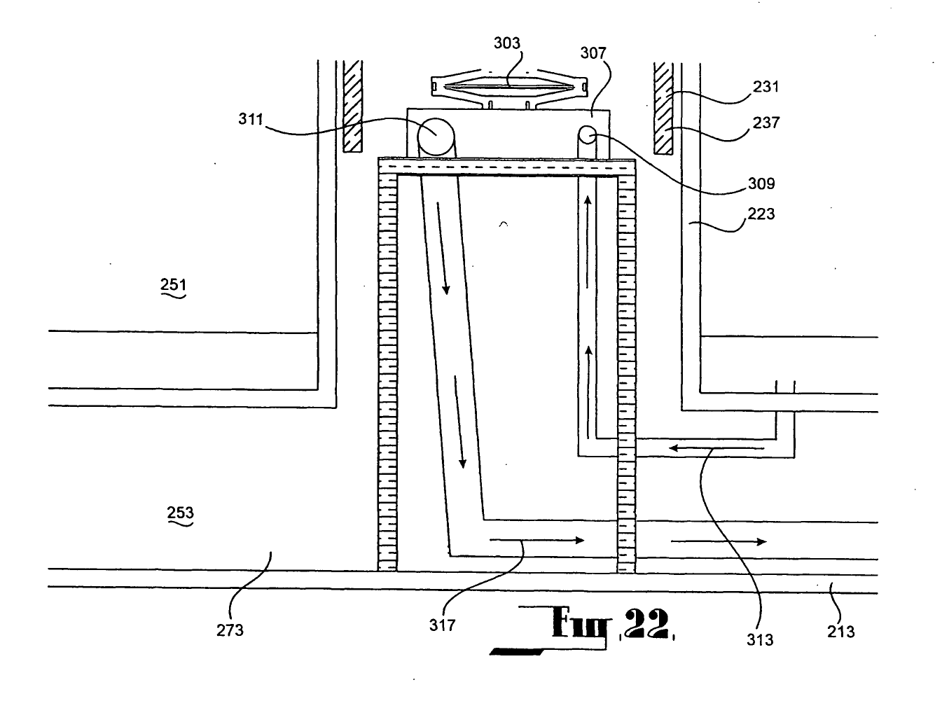

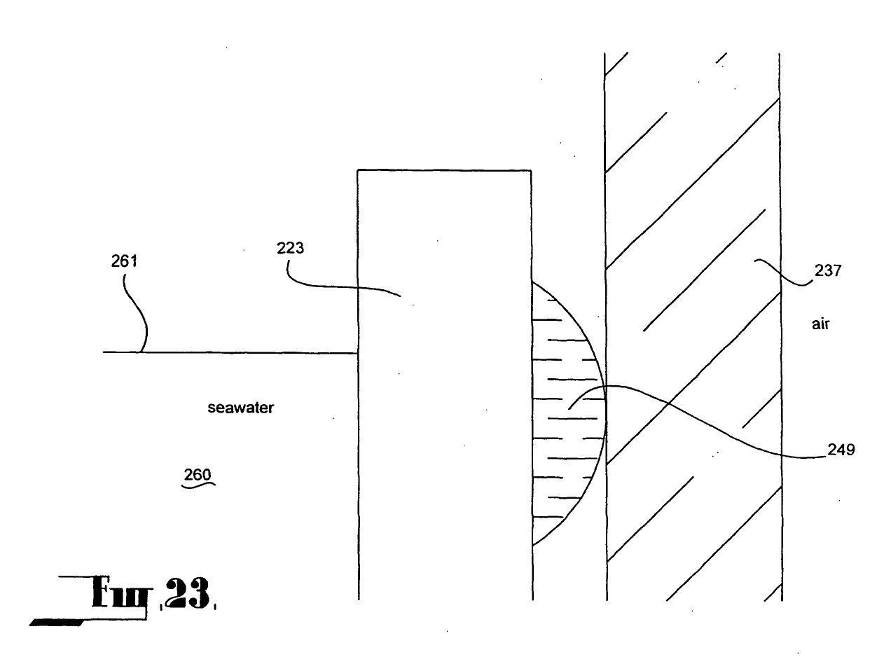

Referring now to FIGS. 14 to 26 of the drawings, the apparatus 200 according to the second embodiment comprises a body structure 211 comprising a base 213 adapted to rest on the seabed 215 and a wall structure 217 located on the base 213. The wall structure 217 includes an outer wall portion 219, an intermediate wall portion 221, and an inner wall portion 223, each of which is of generally cylindrical construction. The wall structure 217 further includes an upper web portion 225 extending between the upper ends of the outer and intermediate wall portions 219, 221, and a lower web portion 227 extending between the intermediate and inner wall portions 221, 223.

The outer wall portions 219 of the body structure 211 extend upwards from the seabed 215 to a point somewhat below the mean level of the sea. The apparatus 200 is placed in relatively shallow waters where there is a significant proportion of wave energy extending downwards from the free water surface. In this manner the apparatus creates a significant peaking of the wave energy as a wave peak passes over it and thus concentrates the energy of the water column onto the upper surface of the apparatus.

The body structure 211 further comprises a plunger 231 operating in cooperation with the wall structure 217. The top of the body structure 211 is rounded along the outer edge and also along the edge adjacent to the plunger 231.

The plunger 231 comprises a circular plate 233, and outer and inner cylindrical wall portions 235, 237 depending therefrom. The plunger outer wall portion 235 cooperates with the intermediate wall portion 221, and the plunger inner wall portion 237 cooperates with the inner wall portion 223, as will be described in more detail later.

With this arrangement, the plunger 231 defines an upper portion 241 of the body structure 211, and the base 213 and wall structure 217 define a lower portion 243 of the body structure 211. The two portions 241, 243 are arranged telescopically with respect to each other, with the lower portion 243 fixed with respect to the seabed 215 and the upper portion 241 being moveable in response to wave action in the ocean.

With the telescopic relationship between the two portions 241, 243, the plunger outer wall 235 slides with respect to the intermediate wall portion 221, and the plunger inner wall 237 slides with respect to the inner wall portion 223.

A plurality of circumferentially spaced guiding runners 245 are disposed between the plunger outer wall 245 and the intermediate wall portion 221. The guiding runners 245 maintain the concentric alignment of the plunger 231 within the apparatus 200 and also allow a relatively low friction sliding contact as the plunger 231 moves vertically in response to wave action. The guiding runners 245 are composed of a material that provides low surface friction as well as having shock absorption properties. Suitable materials may be found in the range of commercially available elastomers. The guiding runners 245 are also designed to wear without fracture, spalling, tearing or ripping. A series of slots (not shown) cut in the intermediate wall 221 form vertical recessed channels that receive and retain the guiding runners 245 to locate them in position. Periodic replacement of the guiding runners 245 may be accomplished by vertical removal of the runner from the slots. This may be accomplished from outside the apparatus 200 by attaching a lifting means to a hook (not shown) on the upper end of each runner and pulling the runner upwards until free of the apparatus. Insertion of new runners is accomplished in exactly the reverse manner.

The presence of the runners 245 establishes a gap 247 between the outer periphery of the plunger 231 and the adjacent inner wall portion 221. The size of the gap 247 is set to allow the free passage of seawater from the surrounds into the apparatus 200, as will be described later. The gap spacing is maintained by the guiding runners 245 and is set to inhibit access by humans or larger sea creatures but to also allow passage of smaller sea creatures such as crayfish or lobsters. The gap spacing may be less than 0.5 metres and preferably less than 0.2 metres.

The apparatus 200 is not closed to the seawater since seawater can readily flow through the gap 247. This is of importance as it obviates the need for a water seal between the upper and lower portions 241, 243. Such seals are problematic in ocean environments where in situ repair would be difficult.

A fluid seal 249 is provided between the plunger inner wall 237 and the adjacent inner wall portion 223.

The upper and lower portions 241, 243 cooperate to define a holding chamber 251 which undergoes volume expansion and volume contraction in response to reciprocatory motion of the plunger 231.

An auxiliary chamber 253 is defined with the body structure 211. The auxiliary chamber 253 is disposed around and below the holding chamber 251 and communicates with the holding chamber 251 by way of apertures 255 in the plunger inner wall 237.

The holding chamber 251 is adapted to receive a volume of seawater from the body of seawater surrounding the apparatus 200 by way of the gap 247, as previously described. The volume of seawater contained in the holding chamber 251 is identified in the drawings by reference numeral 260. The volume of seawater 260 is at a level below the upper edge of the inner wall portion 223 as well as below the apertures 255. The seawater level is depicted in the drawings by a line identified by reference numeral 261.

A volume of air is confined within a zone 273 within the body structure 211. The zone 273 comprises the auxiliary chamber 253 (which is of constant volume) and the upper region within the holding chamber 251 above the volume of seawater 260. With this arrangement, the volume of air under goes compression as the holding chamber undergoes volume reduction upon downward movement of the plunger 231 in response to wave action (or more particularly as a result of increasing hydrodynamic forces acting on the plunger plate 233). In this way, the air acts as a spring which provides a restoring force resisting downward movement of the plunger 231 and urging the plunger in the upward direction upon the subsequent reduction of the hydrodynamic forces.

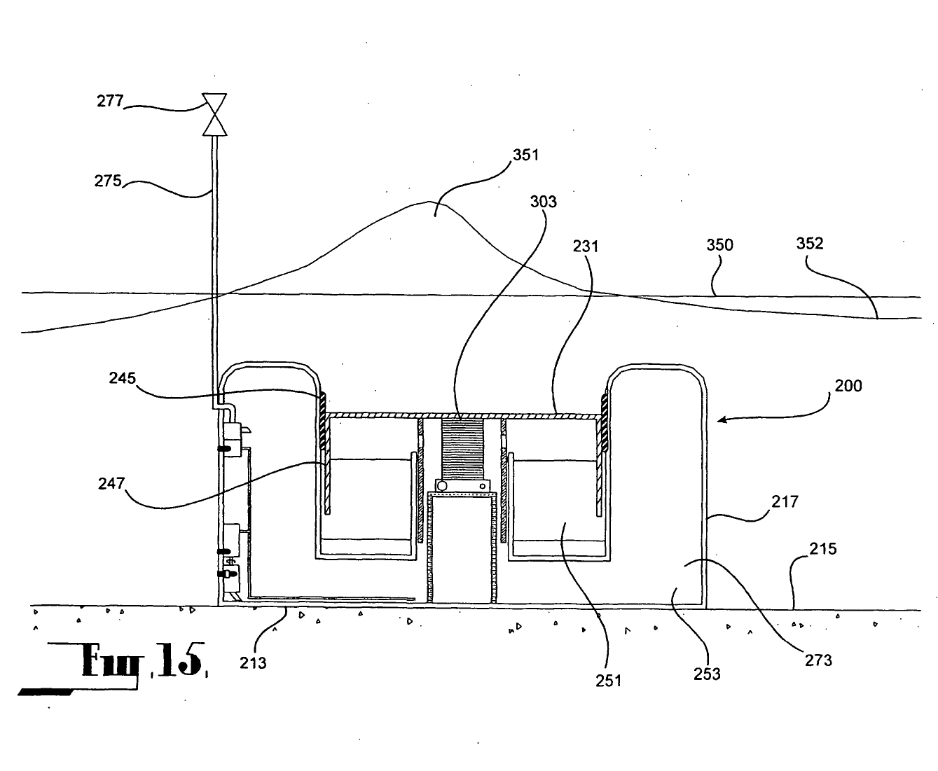

The zone 273 is charged with air delivered from the atmosphere by way of an airline 275 extending upwardly from the body structure 211 to above the ocean surface, as illustrated in FIGS. 14 and 15. The upper end of the airline 275 is fitted with a marker 277 for identification purposes. The airline 275 is connected to an air pump 281 which is accommodated in the auxiliary chamber 253 and which is operable to pump air from the atmosphere into the zone 273, or discharge air from the zone 273 back to the atmosphere, according to the requirements of the apparatus 200 at any particular time. The air pump 281 is driven by a hydraulic motor 283 operated from a supply of pressurised seawater, as will be explained later. Alternatively, the replenishment air may be supplied from a shore-based facility via a pipeline.

The seal 249 is intended to provide protection against splashing from the holding chamber 251 that would otherwise cause a small quantity of seawater to enter the auxiliary chamber 253 and pool at the base 213 of the body structure 211. A water pump 285 is provided to remove any seawater that may gain access passed the seal 249. The water pump 285 has an intake 287 and an exhaust 289 opening onto the surrounding body of seawater. The water pump 285 is driven by a hydraulic motor 291 operated form a supply of pressurized seawater, as will be explained later.

The exhaust 289 communicates directly with the surrounding seawater outside the apparatus 200. The intake 287 is located with its opening close to the base 213. In this manner the pump 285 can act as a bilge pump removing any seawater that migrates thereto. The exhaust 289 of the water pump 285 communicates with the seawater outside the apparatus via a non-return valve. The non-return valve ensures that seawater does not flow back into the apparatus due to the hydrodynamic pressure difference. A non-return valve is not required on the exhaust 292 of the hydraulic motor as the spent water that exits the motor is still at a pressure greater than the hydrodynamic head of the surrounding seawater.

A pumping chamber 301 is disposed between the upper and lower portions 241, 243 and is adapted to undergo volume expansion and volume reduction upon reciprocatory motion of the plunger 231 in response to wave action. The pumping chamber 301 is defined by a bellows pump 303, one end of which is connected to the plunger plate 233 and the other end of which is connected to a frame structure 305 rigidly mounted on the base 213.

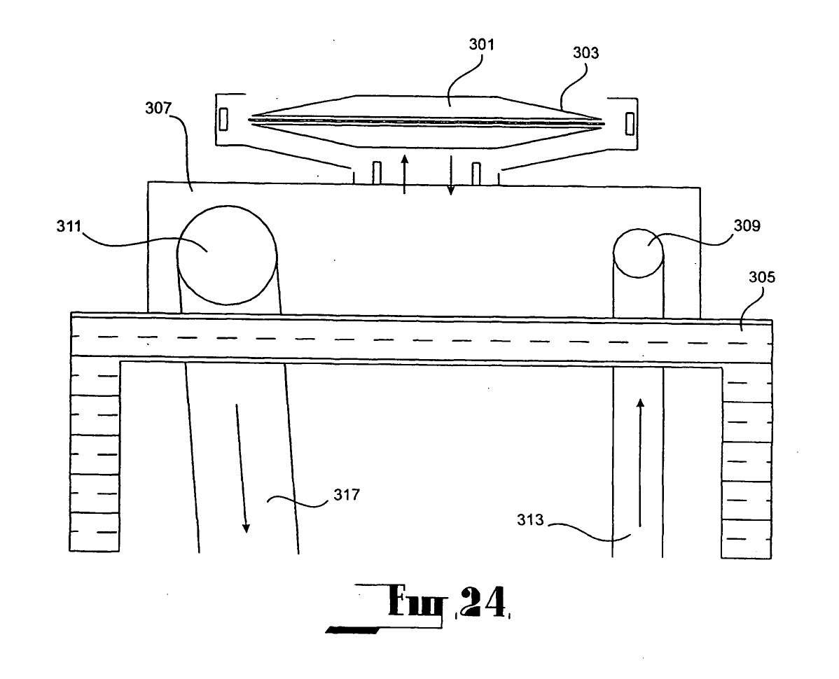

The pumping chamber 301 communicates with a manifold 307 having an inlet 309 and an outlet 311, as best seen in FIGS. 24, 25 and 26. The inlet 309 communicates with the holding chamber 251 by way of a feed line 313 to receive seawater therefrom. The intake end of the feed line 313 is fitted with a filter for filtering the seawater prior to delivery to the pumping chamber 301. The outlet 311 communicates with a high-pressure line 317 along which seawater pressurised in the bellows pump 303 can be conveyed ashore.

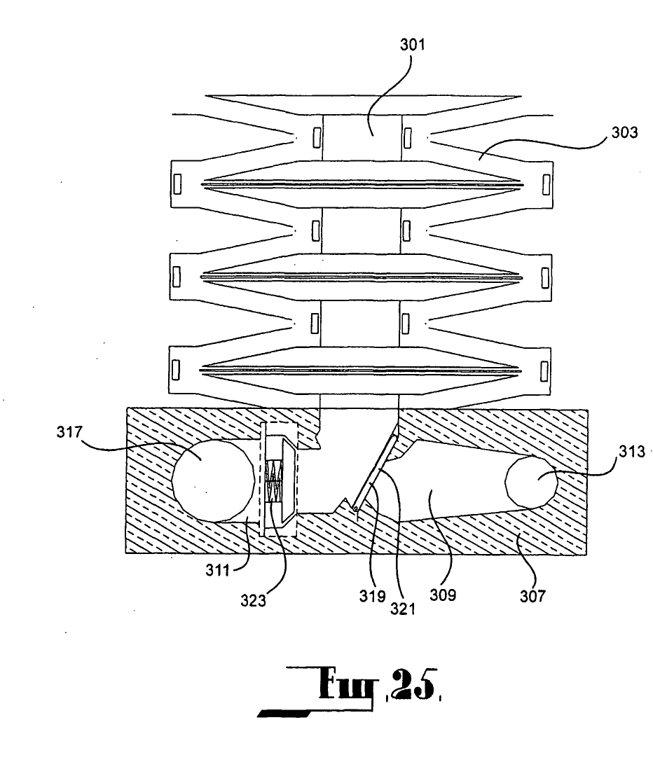

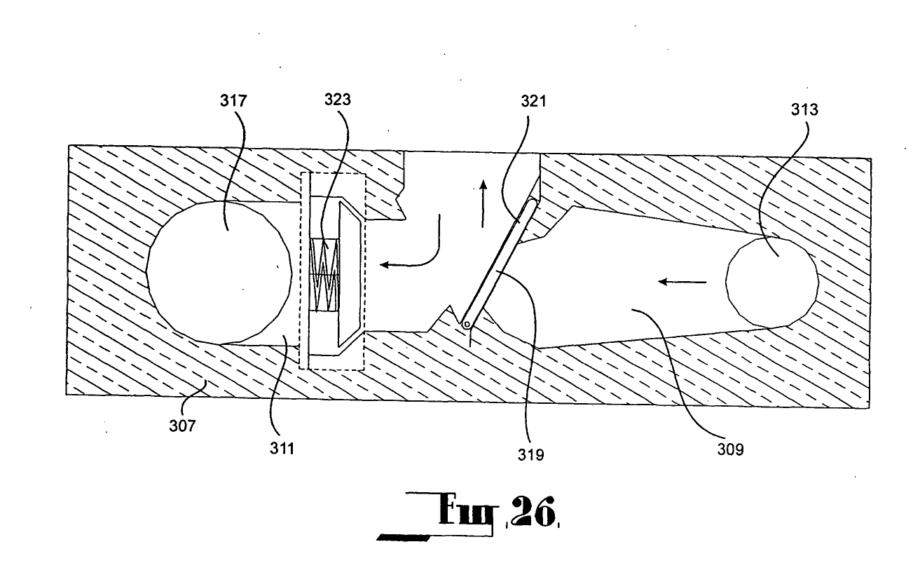

A valve system 319 is associated with the inlet 309 and the outlet 311, as shown in FIGS. 25 and 26. The valve system 319 includes an inlet valve 321 adapted to open upon volume expansion of the pumping chamber 301 and adapted to close upon volume reduction of the pumping chamber 301. In this embodiment, the inlet valve 321 is in the form of a flap valve. The valve system 319 further includes an outlet valve 323 associated with the outlet 311. The outlet valve 323 is adapted to close upon volume expansion of the pumping chamber 301 and to open during volume reduction, but only after seawater contained within the pumping chamber 301 attains a prescribed pressure. In this way, water is discharged from the pumping chamber 301 is at a higher pressure than the intake pressure. In this embodiment, the outlet valve is in the form of a spring-loaded valve.

Operation of the apparatus 200 can be seen with reference to FIGS. 14 and 15. In the drawings, the mean wave position is depicted by a line identified by reference numeral 350, with wave peaks being identified by reference numeral 351 and wave troughs by reference numerals 352. The passage of a wave peak 351, as depicted in FIG. 15, causes the plunger 231 to deflect downwards in response to the water above. After the passage of a wave peak 351, the situation of FIG. 14 applies and the plunger 231 returns to its fully raised position, which is approximately level with the upper surface of the apparatus 200.

The holding chamber 251 is not closed to the seawater. This is an important aspect as it removes the need for a water seal between the upper and lower portions 241, 243.

The level 261 of seawater 260 within the holding chamber 251 is set in part by the pressure of the air above it. In normal operation, the level of the seawater will vary slightly in accordance with the pressure of the air but will be always below the upper edge of the inner wall portion 223. The seawater contained in the holding chamber 251 serves to isolate the seawater surrounding the apparatus 200 from the air contained in zone 273. The holding chamber 251 also provides the feed for the bellows pump 303 via a feed line 313 located at the bottom of the holding chamber 251 and connecting to the low-pressure inlet 309 of the manifold 307. Seawater is drawn up into the pump 303 via the feed line 313 and is replaced by seawater entering from the outside via the gap 247.

A means of reverse flushing the filter at the intake end of the feed line 313 during maintenance periods may be provided by way of extra piping and valves (not shown). The filter may also assist in providing ballast to the apparatus 200.

The hydraulic motor 283 and 291 for driving the air pump 281 and water pump 285 respectively are driven by high-pressure seawater via a takeoff feeder 331 from the high-pressure line 317.

Alternatively the hydraulic motor and pump may be comprised of a pair of positive displacement pumps using elastomer bellows similar to the ones employed for the seawater pressurization. In this case one elastomer bellows would be configured as the motor and the other configured as a pump.

The air pump 281 maintains the air pressure in the zone 273 at a set point wherein the pressure is sufficient to support the weight of the plunger 231 and attachments thereto such that the plunger 231 remains level with the top of the apparatus during a wave trough 352, as shown in FIG. 14. The control of airflow is straightforward given that any air in excess of this pressure will automatically escape from under the plunger 231 via the gap 247 and bubble to the surface.

The air pump 281 may also be made reversible so that it can reduce the pressure within the zone 273. This feature may be employed when it is desired to lower the plunger 231 during storm conditions, or for routine maintenance.

The air in the zone 273, together with the mass of the plunger 231 and attached hardware, constitute an air spring system with a characteristic resonant period. The elastic compliance of the elastomer bellows pump 303 may also contribute to the spring constant of the mechanical system and thus modify the resonant period. The apparatus 200 is sized so that this natural resonant period falls within the range of periods of ocean waves having the dominant energy. Typically, this period ranges between four and 12 seconds. Preferably the range of periods is narrower, from six to ten seconds. Preferably it desired to tune the resonant period to the period of the dominant waves. The damping imposed by the energy extraction, nonetheless broadens the response of the system so that it effectively responds to a range of wave periods.

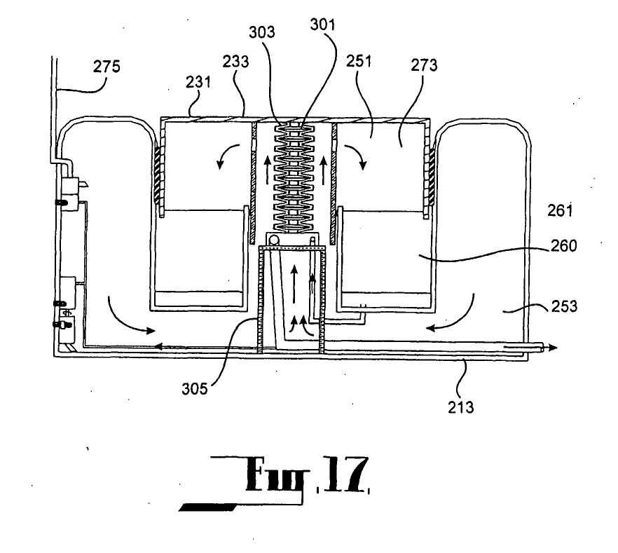

With reference to FIG. 14, the plunger 231 is momentarily at rest during the passage of a wave trough 352. The plunger 231 is at its fully raised position and the bellows pump 303 is momentarily stationary. The bellows pump 303 in maximum extension has drawn up a charge of filtered seawater from the low pressure feed line. Seawater flows into the holding chamber 251 via the gap 247 around the plunger 231 to restore the water level. With reference to FIG. 17, the airflow pattern is such as to equalize the pressure by air flowing from the auxiliary chamber 253 back into the upper region of the holding chamber 251.

With reference to FIG. 15, the plunger 231 is momentarily at rest at its maximally depressed position during the overhead passage of a wave peak 351. The bellows pump 303 is now fully compressed and has delivered its charge of pressurized seawater to the high-pressure line 317 via a one-way valve 323 in the manifold 307.

The extent of pressurization that can be reached within the elastomer bellows pump 303 is determined primarily by the ratio of areas of the plunger 231 to the contact area of the bellows onto the plunger.

It is an aspect of this embodiment that positive displacement pumps, made of elastomer and disposed as bellows, are capable of providing pressures in excess of 70 atmospheres. Any alternative displacement pumps with appropriate pressure and stroke ratings may be substituted in this role without altering the scope of the invention.

This embodiment utilizes a single-ended pumping arrangement in that pressurization of seawater within the single bellows pump 303 occurs only on the downward stroke of the plunger 231. The upward stroke merely expands the bellows and causes the flap valve 321 in the manifold 307 to open to the low pressure feed line 313 and allow the bellows to fill with a fresh charge of seawater under the action of suction. During compression, the flap valve 321 in the manifold 307 closes on the low-pressure line 313 exposing the bellows charge to the high-pressure line 317. The one-way valve 323 will open when the pressure of this water reaches a preset threshold admitting high-pressure water to the line.

The second embodiment utilizes a single bellows pump 303 mounted on the support frame 305. The stroke of the single bellows pump may be made larger than the stroke of individual bellows in the later embodiments and this offsets the inherent disadvantage of employing a single-ended pumping scheme vis a vis a push-pull arrangement as in the later embodiments.

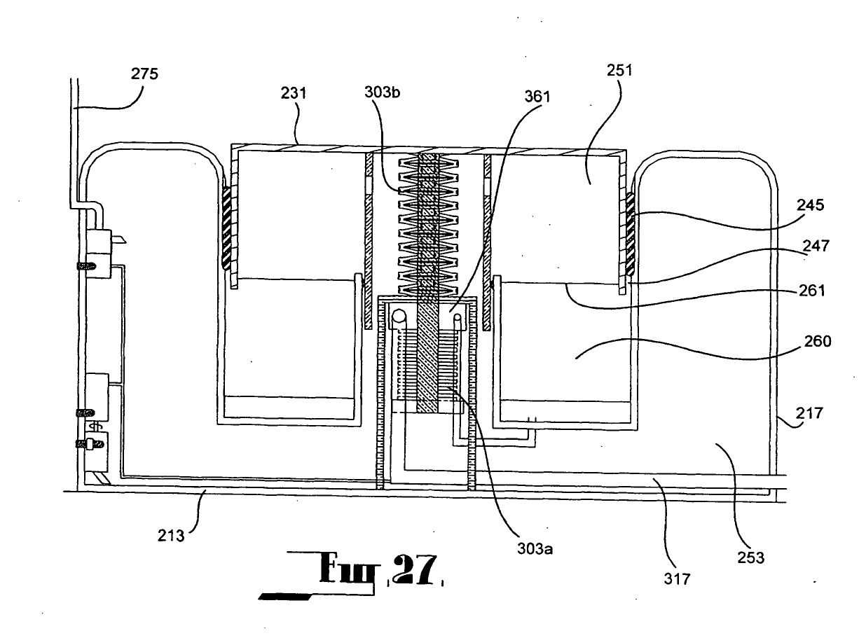

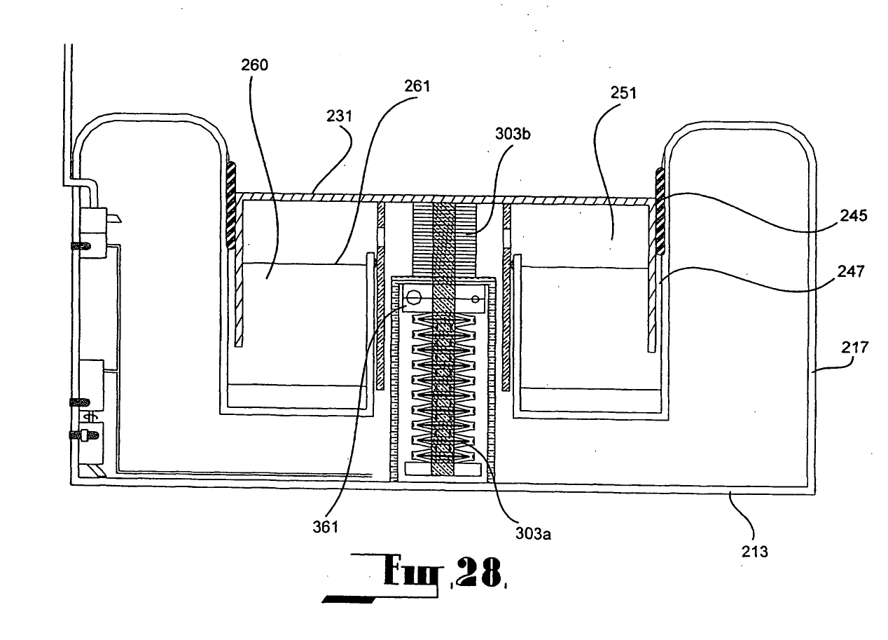

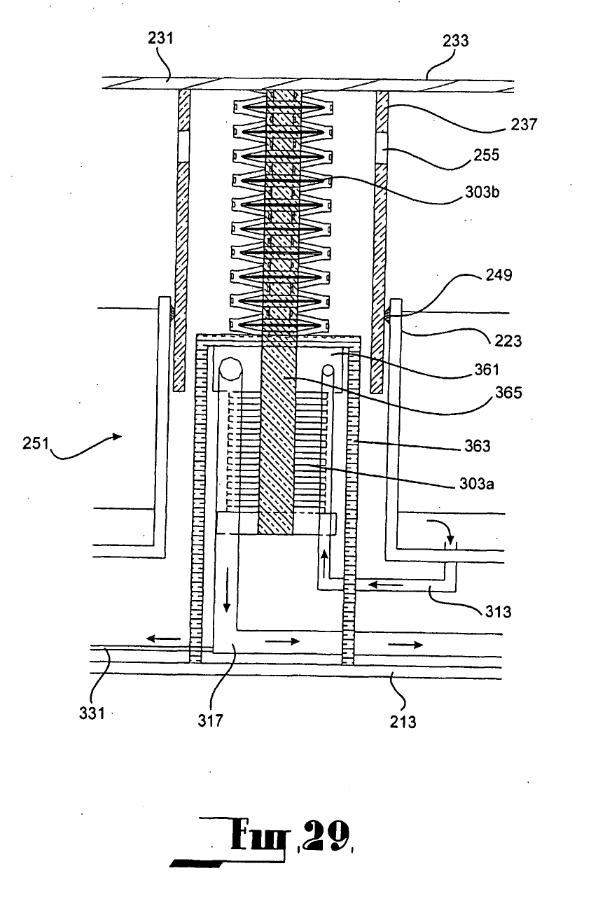

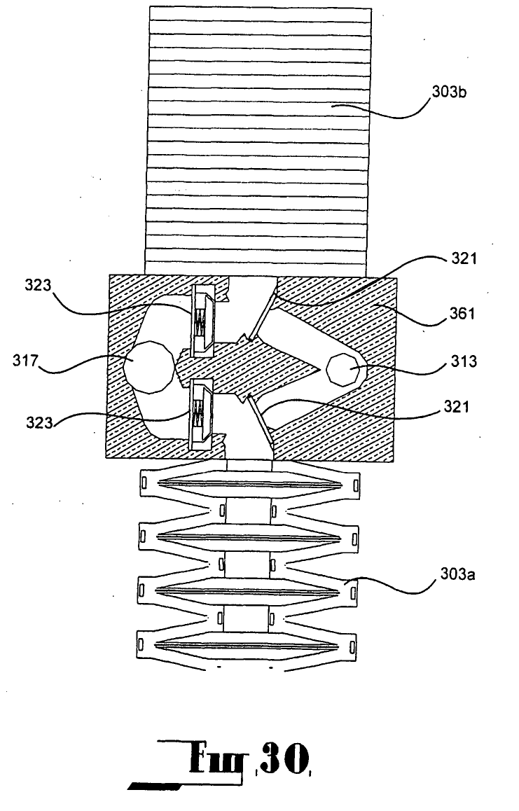

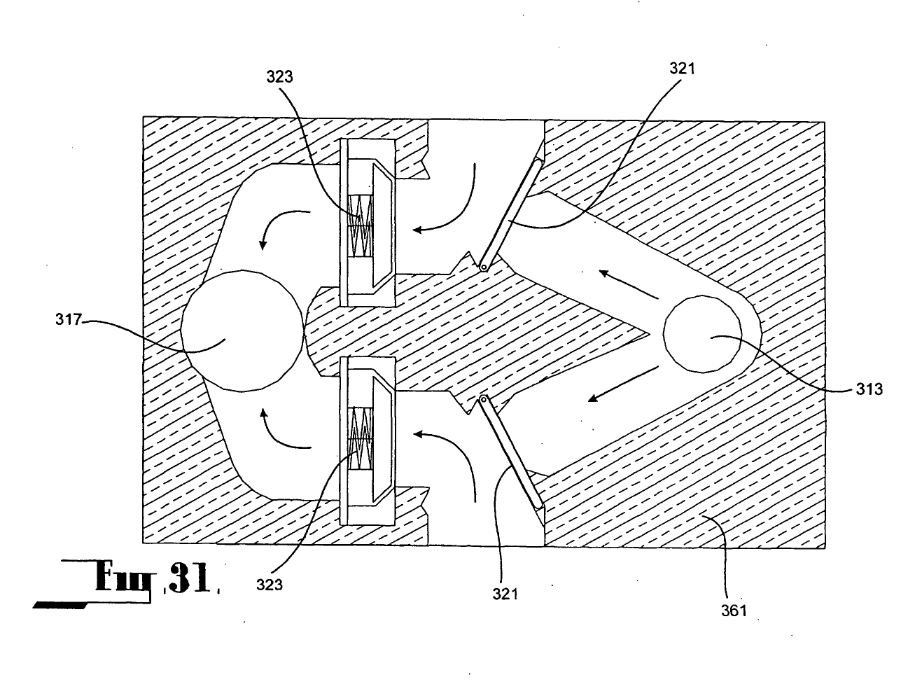

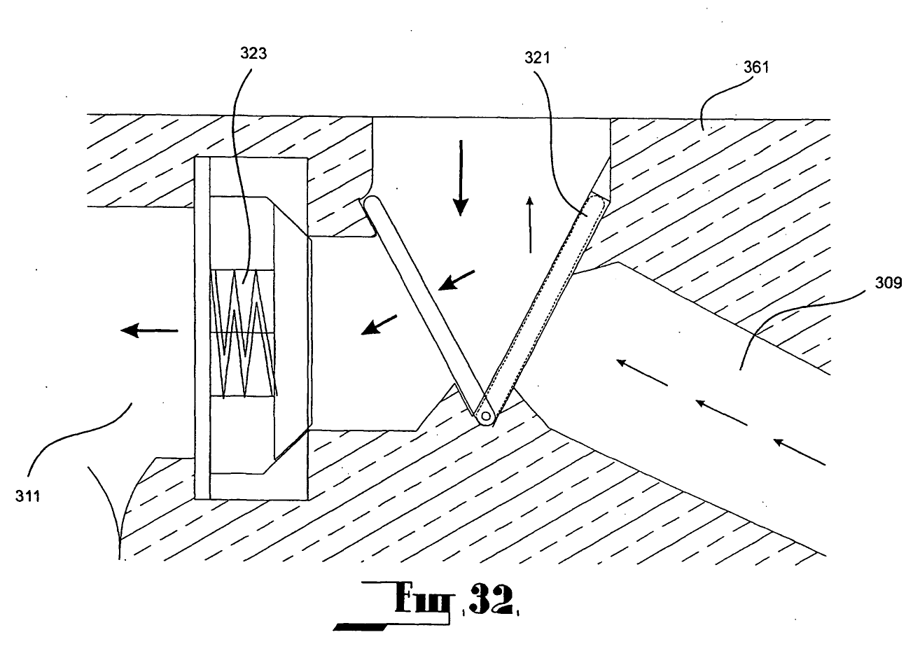

Apparatus according to a third embodiment of the invention is shown in FIGS. 27 to 32. This embodiment employs a push-pull pumping arrangement wherein seawater is pressurized on both the upward and the downward stroke of the plunger 231. This is achieved with two bellows pumps 303a, 303b working in opposition. The pumps are disposed axially one above the other with a dual manifold 361 interconnecting the two bellows. The dual manifold 361 contains within one housing two sets of one-way valves 323 and flap valves 321 that are each identical to the elements in the manifold 307 of the first embodiment. The dual manifold 361 is rigidly attached to a rigid support frame 363 that is attached to the base 213 of the apparatus. A rigid connecting strut 365 attaches at one end to the base of the lower bellows 303a and communicates force to the plunger 231 where the other end is rigidly attached. The upper bellows 303b is rigidly attached to the underside of the plunger 231 while its other end is rigidly attached to the support frame 363. Downward motion of the plunger 231 causes the upper bellows 303b to contract producing pressurized seawater while the lower bellows 303a expands and draws in seawater. On the upward stroke the situation is reversed.

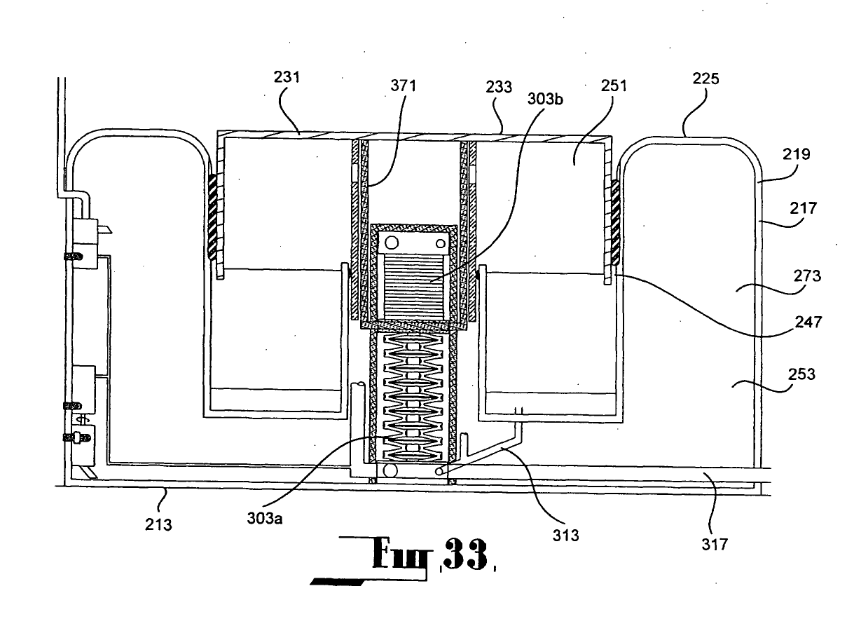

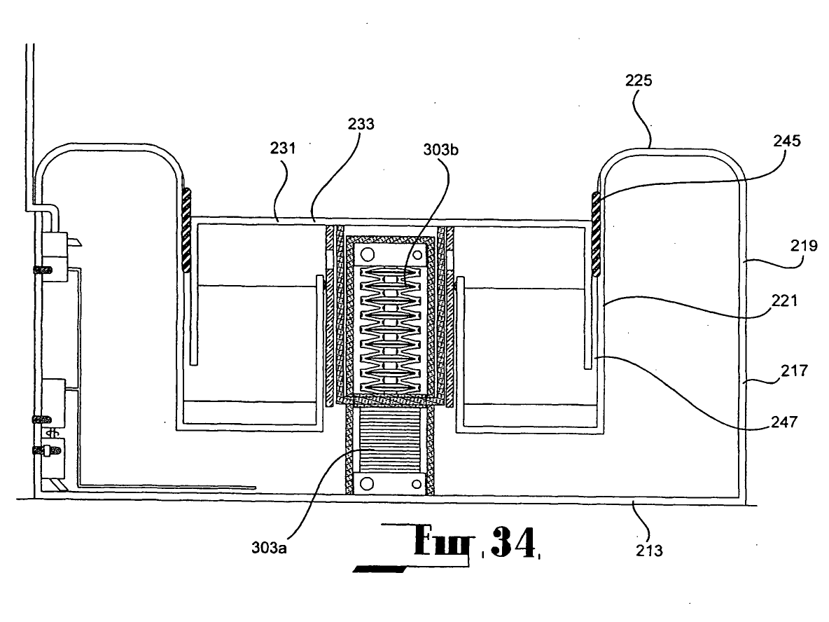

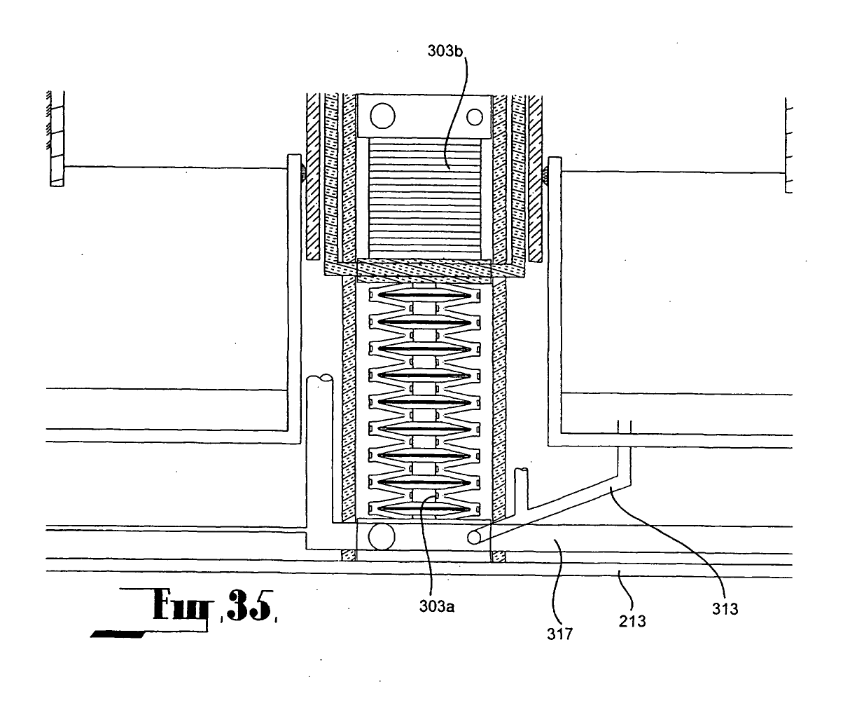

Apparatus according to a fourth embodiment of the invention is shown in FIGS. 33 to 35. This embodiment employs the same manifold and same type of valve arrangement as the second embodiment but uses a push-pull pumping scheme using two bellows 303a, 303b similar to the second embodiment. The difference between the third and fourth embodiments is in the manner in which the bellows 303a, 303b are stretched. In the fourth embodiment, the outer ends of the bellows 303a, 303b are fixed and provide the connection to the manifold for fluid feed and take off. The centre connection between the two bellows is rigidly connected to a frame 371 that is then rigidly connected to the plunger 231. In this way the central connection between the bellows 303a, 303b moves with the plunger 231 while the ends of the bellows remain fixed. This is the opposite of the second embodiment wherein the central portion and dual manifold remain fixed but the ends of the bellows move. The third embodiment utilizes a more complex manifold than either the second or fourth embodiment whereas the fourth embodiment requires extra piping to connect to the two sets of manifolds.

It is apparent that the third and fourth embodiments provide power strokes on both the upward and downward motions of the plunger 231 but with a displacement per bellows that is less than that provided by the single-ended bellows arrangement of the second embodiment. The third and fourth embodiments provide a somewhat smoother production of pressurized seawater than the single-ended arrangement of the second embodiment.

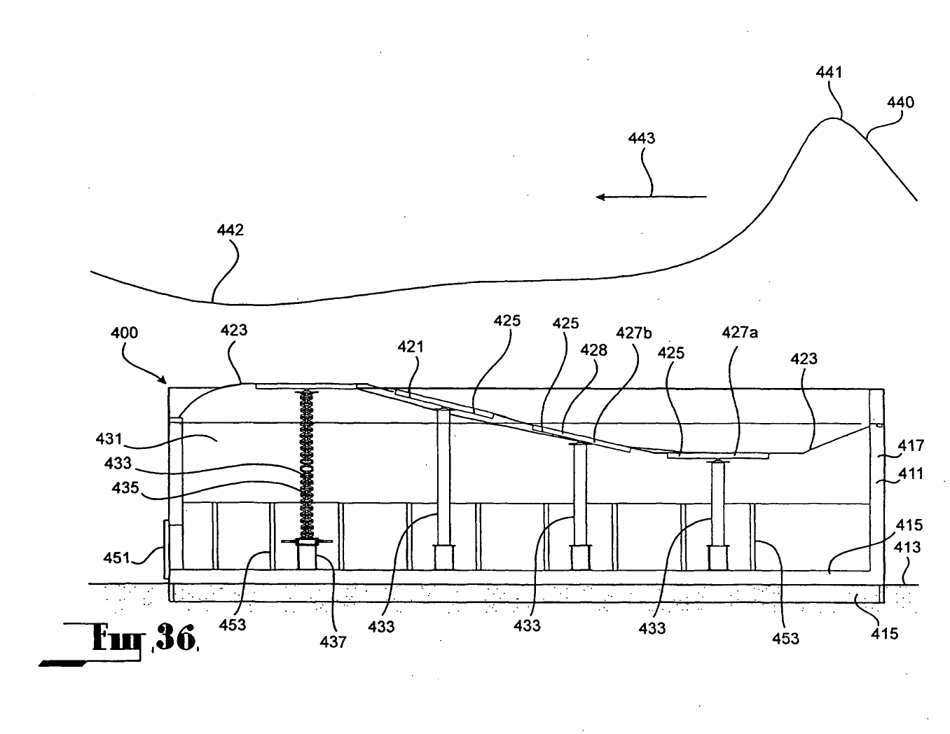

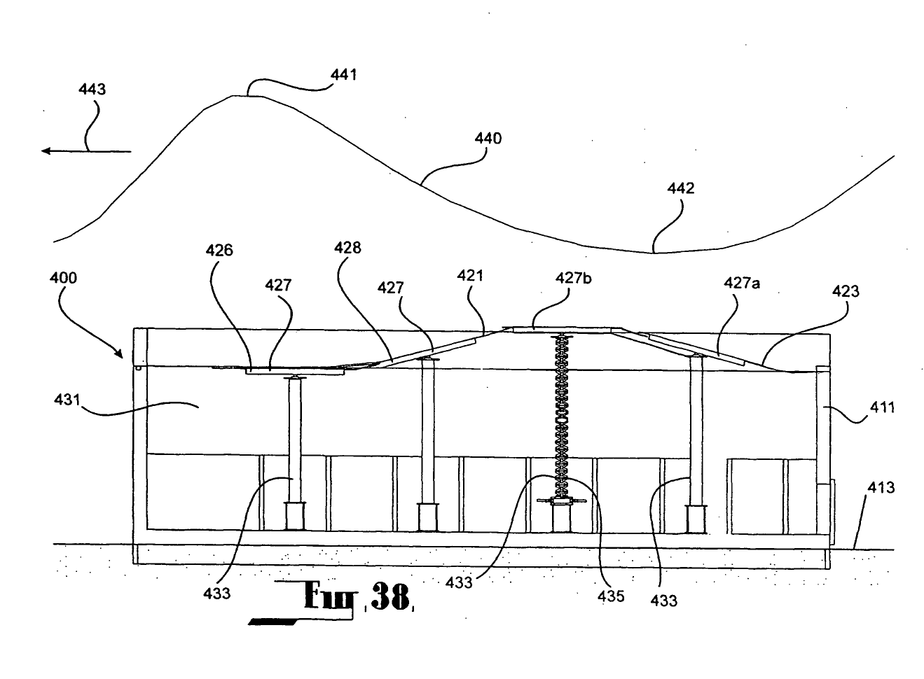

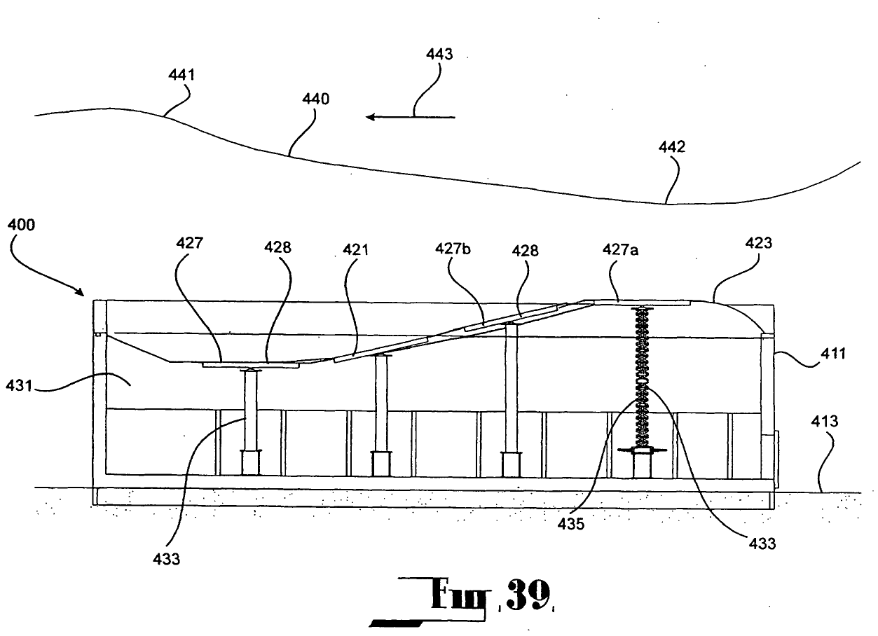

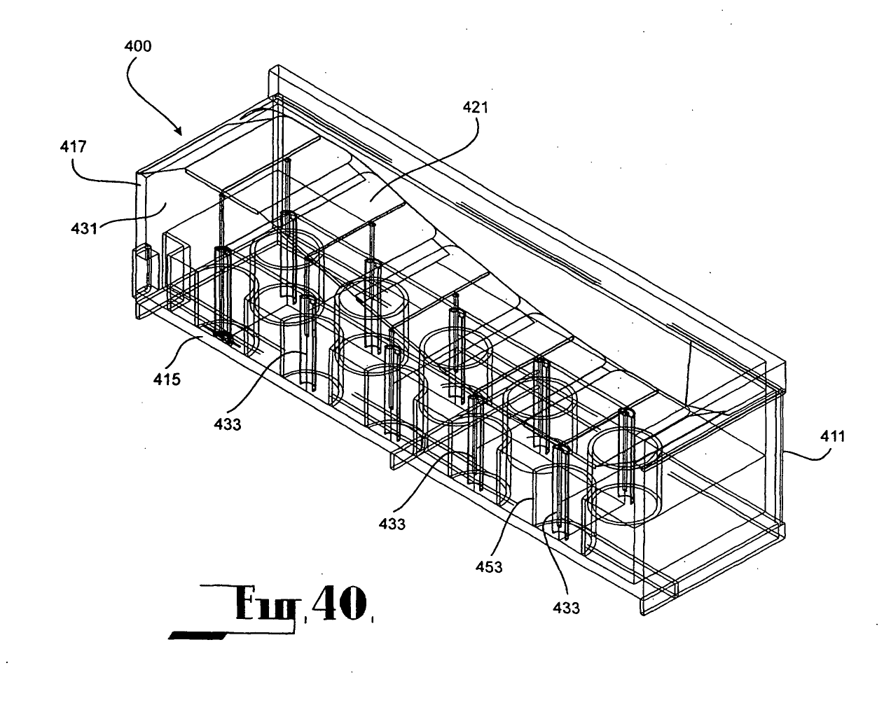

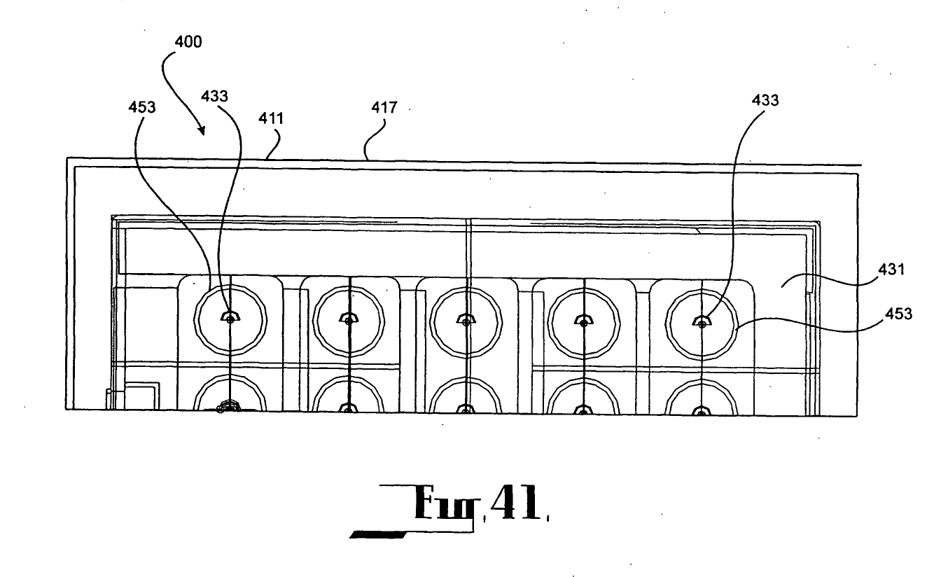

Referring now to FIGS. 36 to 41, there is shown apparatus 400 according to a fifth embodiment. The apparatus 400 comprises a body structure 411 resting on the seabed 413. A skirt 415 attached to the perimeter of the body structure 411 on the underside thereof, protrudes down into the seabed 413 and aids in attachment to the seabed. Sea anchors (not shown) may also be attached to the body structure 411 in order to further improve attachment to the seabed.

Marker buoys (not shown) are provided at the corners of the body structure 411 and extend vertically upwardly beyond the water line and into the open air, to provide visual, audible and other means of identifying the location of the apparatus 400.

The body structure 411 is of hollow construction, comprising a base 415 adapted to rest on the seabed 413 and a peripheral wall structure 417 located on the base 415.

The top of the body structure 411 is bounded by the peripheral wall 417 which defines an opening closed by a flexible diaphragm 421 adapted to deflect in response to wave action.

The diaphragm 421 comprises a flexible portion 423 defined by an elastomeric membrane and a plurality of rigid portions 425 defined by plates 427. In this embodiment, there are four such plates 427, but the actual number of plates can vary according to the performance characteristics required of the apparatus. The plates 427 are disposed in a substantially concatenate relationship extending in the direction of wave travel and are adapted for articulation one with respect to another. The plates 427 are spaced apart in the concatenate relationship to permit angular movement therebetween, with the connection between adjacent plates being provided by the flexible membrane 423. With this arrangement, the plates 427 provide an articulated structure 428.

The length of any individual plate 427 along the wave direction is less than about one-half of the wavelength of the shortest wave for which useful energy is desired to be extracted.

The flexible membrane 423 provides a watertight closure for the open upper end of the body structure 411.

An interior space 431 is defined between the body structure 411 and the flexible diaphragm 421. The interior space 431 is disposed immediately below the flexible diaphragm 421 and contains a compressible fluid which conveniently is air. The air is under pressure to provide a lifting force to counterbalance the weight of the flexible diaphragm 421 and seawater above the diaphragm. The air pressure can be adjusted so as to maintain the diaphragm 421 at a predetermined position in calm sea conditions, as was the case with earlier embodiments.

In contrast to earlier embodiments, in this embodiment the volume of the interior chamber 431 does not substantially change with deflection of the flexible diaphragm 421, as will explained in more detail later.

A positive displacement pump 433 is operatively connected to each plate 427. In this embodiment, each positive displacement pump 433 is in the form of a bellows structure 435 configured as a bellows column, as was the case with earlier embodiments. One end of each bellows column 435 is connected to each respective plate 427 and the other end is mounted on an adjustable support 437 positioned on the base 415.

Each bellows structure 435 is adapted to extend and contract is response to movement of the diaphragm 421. More particularly, each bellows structure 435 is adapted to extend and contract in response to movement of its respective plate 427 within the diaphragm 421.

Each bellows structure 435 incorporates a pumping chamber and an associated inlet and outlet valve system, as was the case with earlier embodiments, whereby seawater can be drawn into the pumping chamber and discharged therefrom at a higher pressure.

Operation of the apparatus 400 will now be described with reference to FIGS. 36 to 39 of the drawings. As can be seen in those drawings, wave activity is depicted by a line identified by reference numeral 440, with wave peaks being identified by reference numeral 441 and waves troughs by reference numeral 442. The direction of wave travel is depicted by directional arrow identified by reference numeral 443.

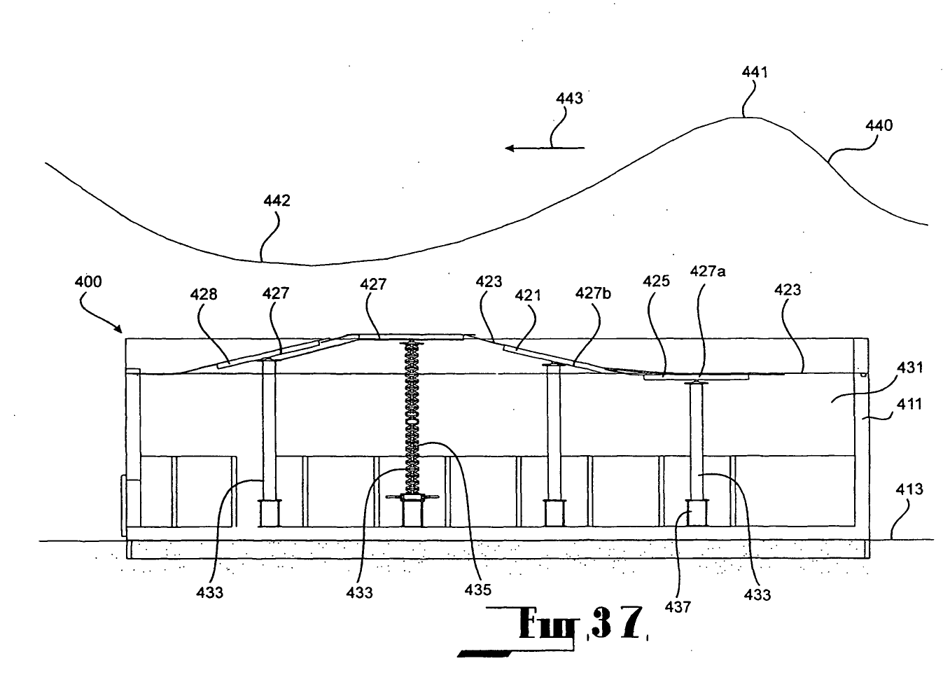

A wave 440 incident on the apparatus 400 acts upon the diaphragm 421 to cause the first plate 427a encountered by the wave to deflect downwardly, and the next plate 427b to also deflect downwardly but to a lesser extent. With reference to FIGS. 37, 38 and 39, it is evident that the deflection of the plates 427 follow a pattern which is in phase with the wave peak 441 as it rolls over the apparatus 400. In this way, the plates 427 move essentially in anti-phase with the wave 440. It is a feature of this embodiment that the articulated structure 428, which is provided by plates 427 connected together by the elastomeric membrane 423, is able to respond to the wave pressure changes due to the moving mass of water.

The pressure and volume of fluid (typically air) contained within interior chamber 431 remains approximately constant, the fluid (air) merely being redistributed within the chamber 431 upon deflection of the flexible diaphragm 421. More particularly, the effect of one plate 427 deflecting downwardly under an increased water mass is to cause a redistribution of the fluid (air) such as to force upwardly those plates having a lesser mass of water above them. This equalisation effect provides the restoring force to ensure that the articulated structure 428 provided by the plates can deflect to a contour that mimics by approximation the image of the wave passing overhead.

Because of the angular movement of the plates 427 in the articulated structure 428, each plate undergoes some tilting motion about horizontal axis substantially perpendicular to the wave direction. Such tilting motion may be accommodated in any suitable way, such as by provision of a hinged joint between each plate 427 and its respective pump 433.

The body structure 411 may be provided with an access hatch 451 to facilitate access to the interior chamber 431 for the purpose of maintenance and repair. The access hatch 451 is provided in the peripheral wall 417 at a location adjacent the base 415 so as to be at a level close to the seabed and isolated from the path of movement of the flexible diaphragm 423. The floor area in the chamber 431 is approximately at seabed level so that a diver is able to stand upright without encountering the flexible diaphragm.

The body structure 411 also has provision to accommodate ballast, so providing control in relation to neutral or positive buoyancy of the apparatus.

In this embodiment, liners 453 are disposed around the pumps 433, so that the space within the interior chamber 431 located exteriorly of the liners 453 can receive ballast material. The liners 453 thus provide a containment wall for isolating the pumps 433 from the ballast material. The ballast material can be pumped into the apparatus during initial submersion, or when the apparatus is emplaced on the seabed 413.

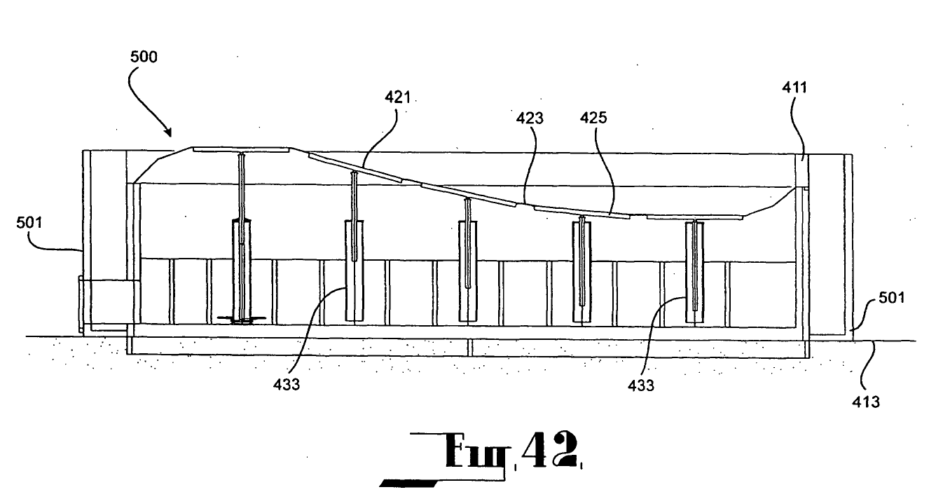

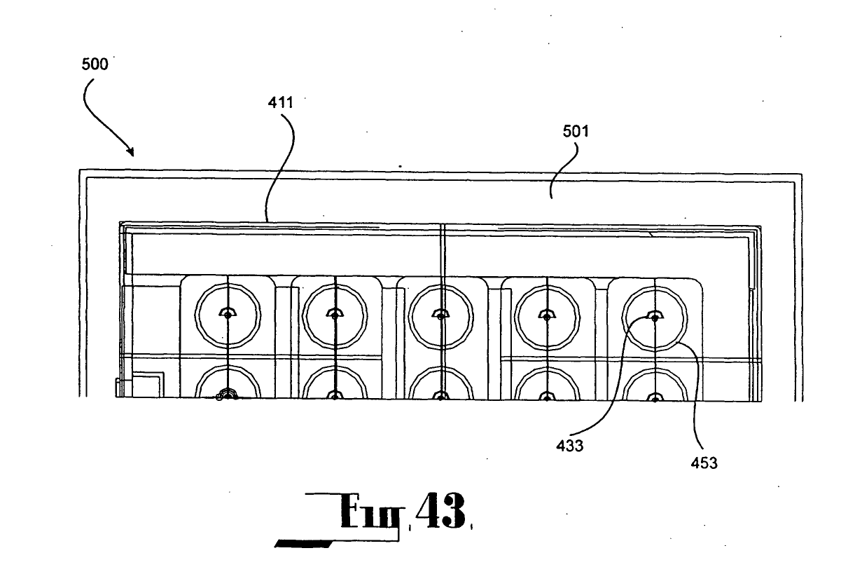

Referring now to FIGS. 42 and 43, there is shown apparatus 500 according to a sixth embodiment. The apparatus 500 is similar in almost all respects to the apparatus 400 according to the previous embodiment, and so corresponding reference numerals are used to identify similar parts. In this embodiment, however, a trough 501 extends around the outer side of the peripheral wall 417 adjacent the base 415. The trough 501 is adapted to receive ballast material, such as sand dredged from the adjacent seabed, thus providing additional ballast for the apparatus.

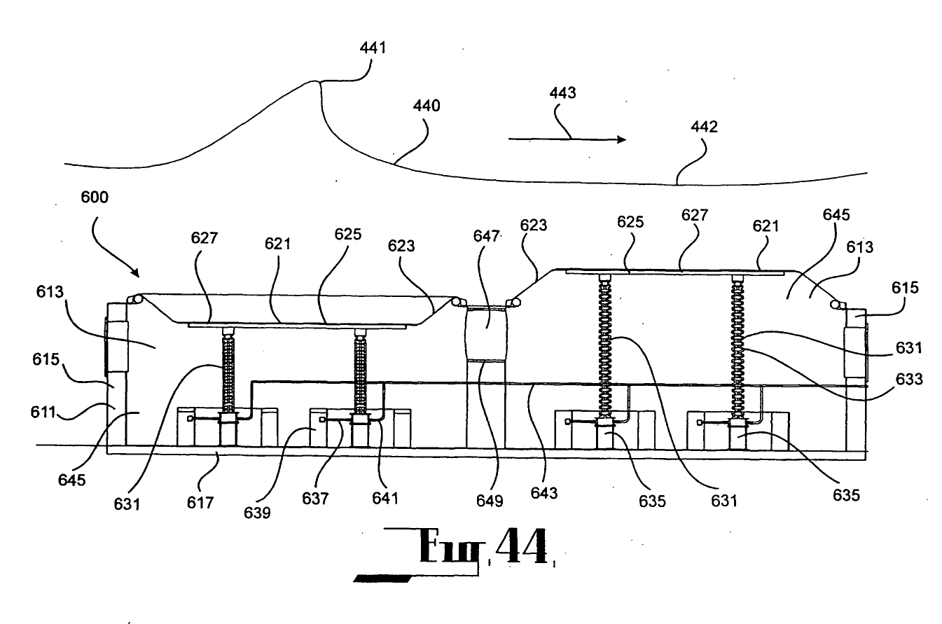

Referring now to FIGS. 44 to 48, there is shown apparatus 600 according to a seventh embodiment. The apparatus 600 comprises a body structure 611 incorporating a plurality of discrete cells 613. Each cell 613 comprises a cylindrical wall 615 projecting upwardly from a base 617 of the body structure 611. The upper end of each cylindrical wall 615 defines an opening closed by a flexible membrane 621. The flexible diaphragm 621 comprises a flexible portion 623 defined by an elastomeric membrane and a rigid portion 625 defined by a circular plate 627 disposed centrally with respect to the elastomeric membrane 623 on the underside thereof.

There is at least one positive displacement pump 631 operatively connected to the rigid plate 623. More particularly, in this embodiment, there are three such pumps 631 operatively connected to each plate 623, with the pumps being arranged in a delta configuration. Each pump 631 is in the form of a bellows structure 633 configured as a bellows column, as was the case with earlier embodiments. One end of each bellows column is connected to the rigid plate 627 and the other end is mounted on an adjustable support 635.

The bellows structures 633 in each cell 613 extend and contract in unison in response to movement of the respective flexible diaphragm 621. Each bellows structure 633 incorporates a pumping chamber (now shown) having an inlet 637 to receive filtered seawater via a filter 639. Each bellows structure 633 also has an outlet 641 communicating with an outlet manifold 643 which is common to the bellows structures in the various cells 613.

An interior space 645 is defined within each cell 613 below the respective flexible diaphragm 621. The interior spaces 645 communicate with each other by way of communication paths 647 defined by ducts 649 extending between neighbouring cells 613. The ducts 649 have sufficient cross-sectional flow area to allow free passage of fluid (typically air) between the chambers 645.

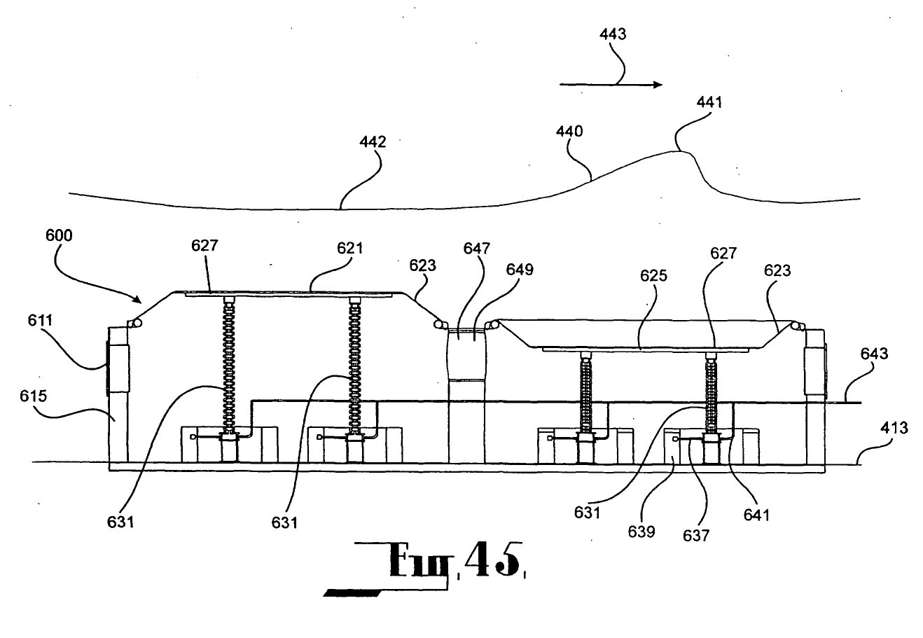

The principle of operation is similar to that of the previous embodiment in so far as the total fluid (air) pressure and fluid (air) volume within the apparatus are on average constant, so that the plates 627 may move in antiphase with the wave activity, as seen in FIGS. 44 and 45.

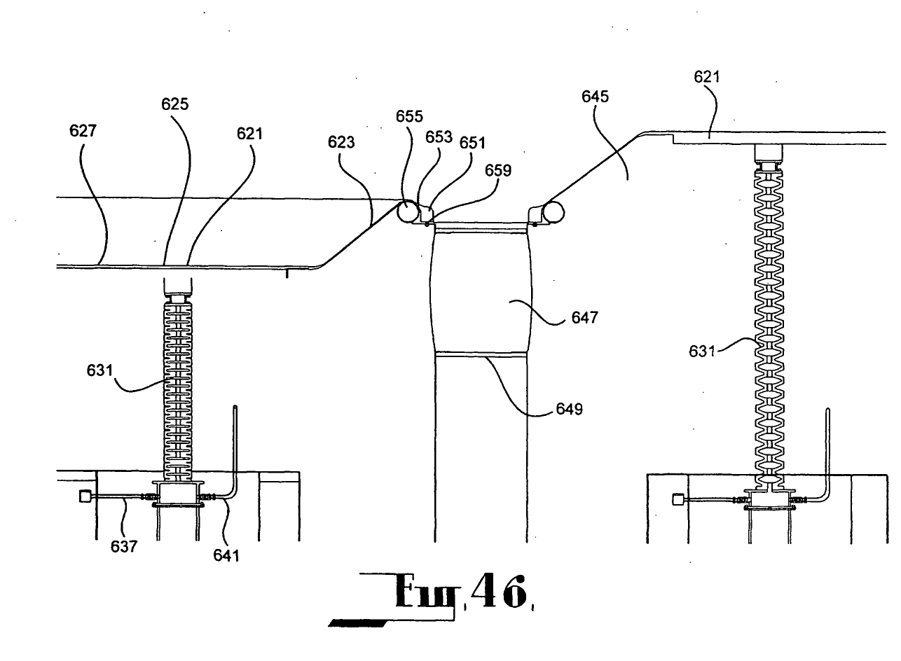

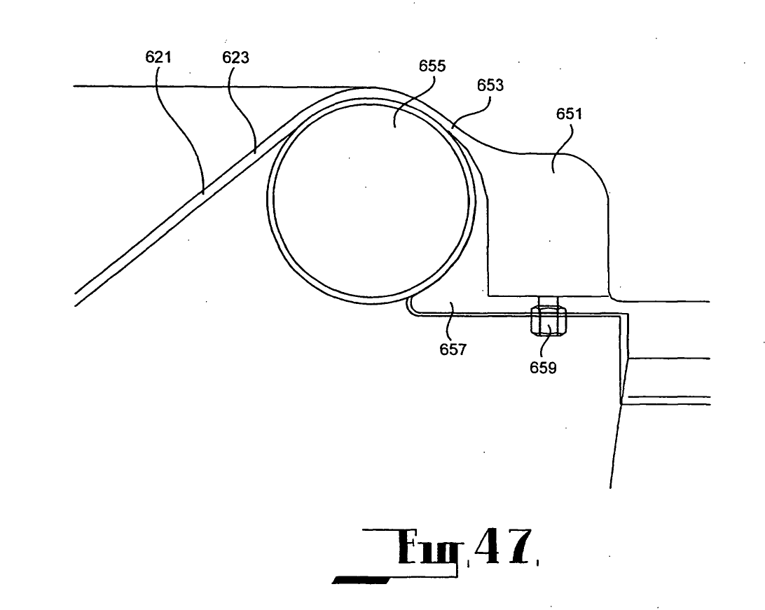

The manner in which the elastomeric membrane 623 is attached to the peripheral wall 615 of each cell 613 is illustrated in FIGS. 46 and 47 of the drawings. The elastic membrane 623 incorporates an anchor portion 651 at its outer peripheral portion 653. The outer peripheral portion 653 of the membrane 623 passes over a structural ring 655 supported in a seat 657 provided on the peripheral wall of the cell. The anchor portion 651 is attached to the mounting bracket on the wall by way of a fastener 659. The circular cross-section of the structural ring 655 ensures that the membrane 623 wraps around the surface of the ring as the plate 627 moves and the membrane expands and contracts. This is particularly advantageous, as it ensures that there is minimal wear on the elastomeric membrane.

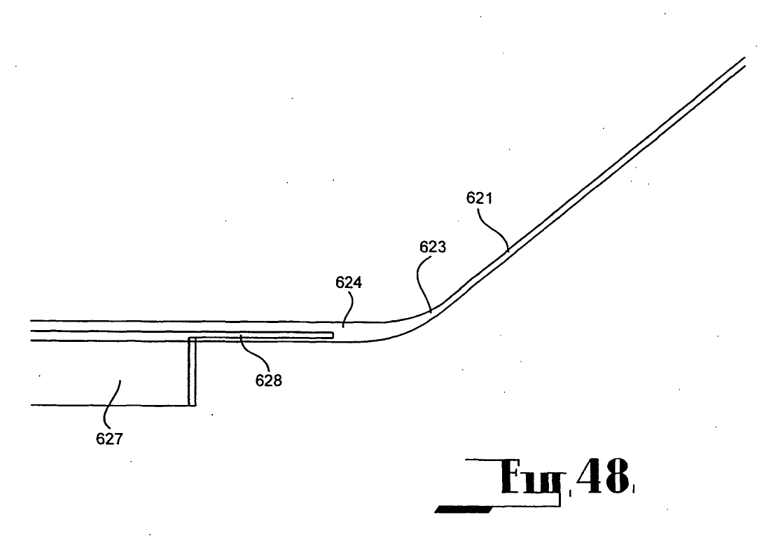

The manner of attachment between the elastomeric membrane 623 and the plate 627 is illustrated in FIG. 48 of the drawings. The plate 627 incorporates an attachment flange 628 which locates against the membrane, the portion 624 of the membrane 623 adjacent the plate being thickened to facilitate attachment. As can be seen in the drawing, the membrane progressively tapers to the thickened portion 624.

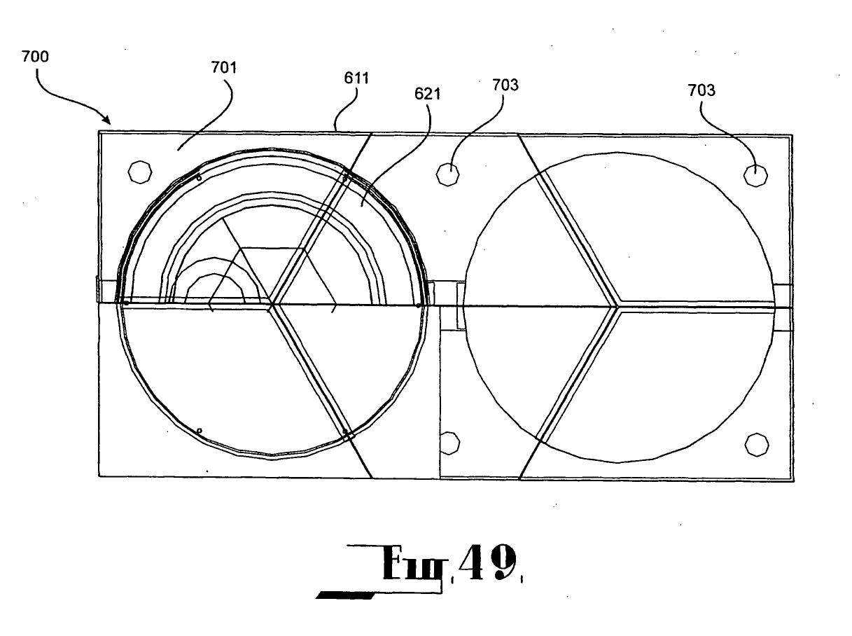

Referring now to FIG. 49, there is shown apparatus 700 according an eighth embodiment. The apparatus 700 is substantially the same as the apparatus 600 according to the previous embodiment (with corresponding reference numerals being used to identify similar parts), with the exception that a ballast chamber 701 is provided on the base 617, surrounding the cells 613. The space within the ballast chamber 701 can receive ballast. In this embodiment, the ballast can be introduced into the ballast chamber 701 by way of filler holes 703 in the top 705 thereof.

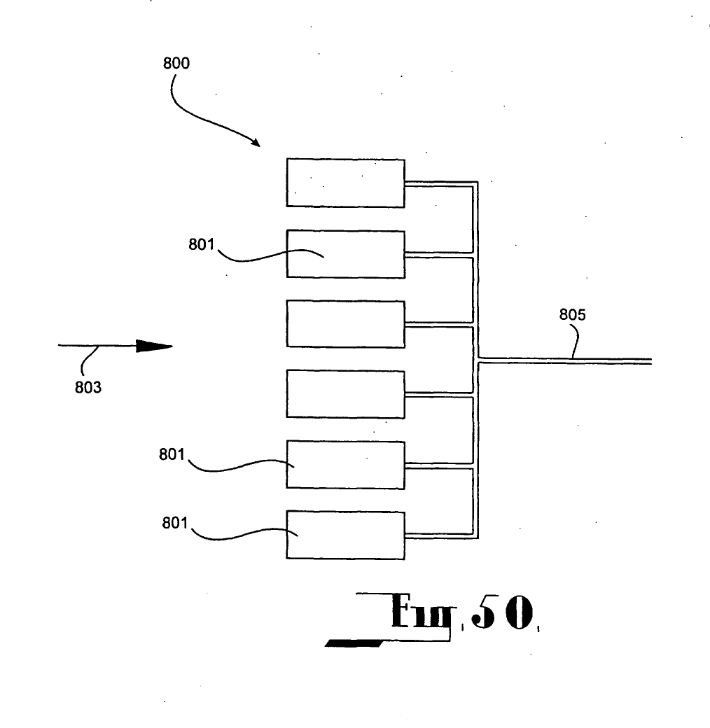

Referring now to FIG. 50 of the drawings, there is shown a system 800 for capturing wave energy. The system involves an array of units 801 operating in concert. The units 801 may each take the form of any of the wave energy apparatus according to the previous embodiments. In the system 800, the units 801 are spaced one with respect to another in a direction transverse to the wave direction as depicted by the directional arrow identified by reference numeral 803. The units 801 communicate with a common line 805 for delivery of pressurized seawater to a remote location, typically shore-based.

The spacing of the units 801 in the array is at a distance determined by the wavelength of the typical wave likely to be encountered by this system. This provides an optimum spacing between units 801 in the array. Spacing the units too close together causes wave interaction between the units and less efficient energy capture, while spacing them to far apart will cause the amount of energy per unit length along the wave front to be diminished. Either of the situations is undesirable from the point of view of maximising the energy uptake from an array while minimising the total capital cost.

Each of the embodiments described may have features which are not described and illustrated in other embodiments. It should be understood that features of any one embodiment described and illustrated may, where appropriate, be applicable to any one or more of the other embodiments.

Each of the embodiments described previously has utilized a positive displacement pump in the form of a bellows structure configured as a bellows column. Such a bellows structure is particularly advantageous as it avoids problems encountered by pumps of the type having a plunger reciprocating in a cylinder in a corrosive environment. This is because the working surface of the pumping chamber, which undergoes expansion and contraction movement during operation of the pump, is of elastomeric construction. The bellows construction is also more reliable in conditions of varying wave heights and frequencies than conventional pumps involving a piston reciprocating within a cylinder.

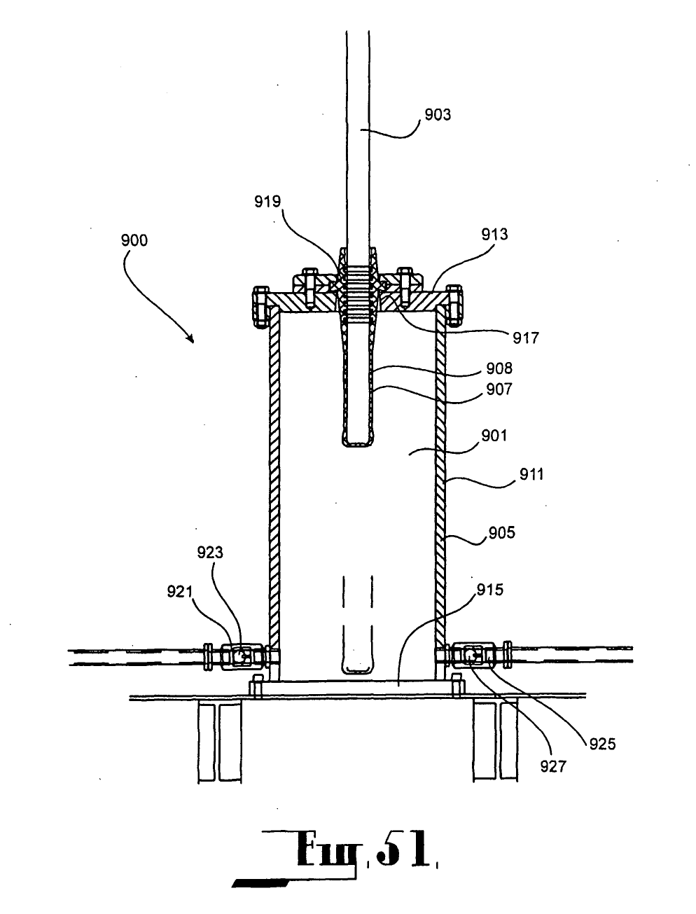

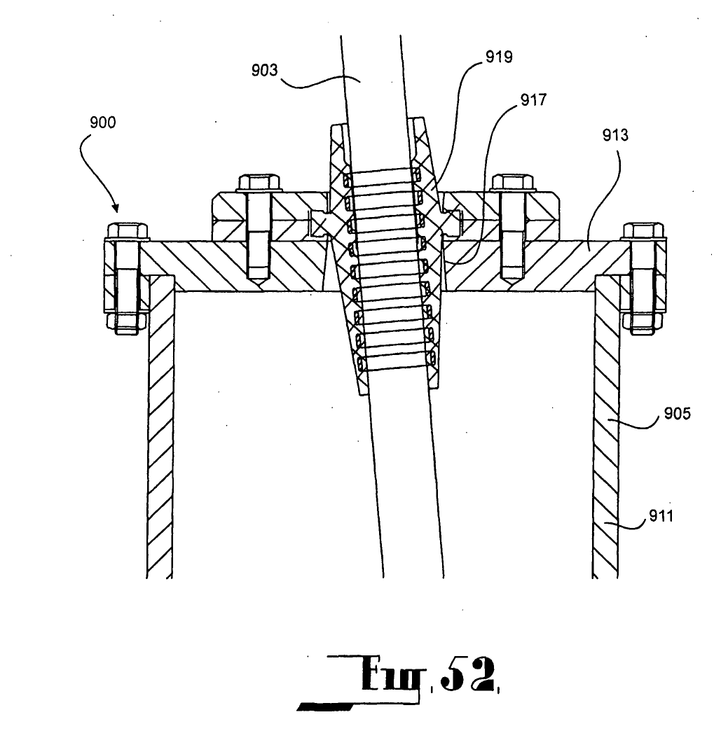

A pump that can be substituted for the various bellows structures in the embodiments described is illustrated in FIGS. 51 and 52 of the drawings. The pump 900 comprises a pumping chamber 901, and a reciprocating piston 903 operatively connected to the portion of the wave energy capturing apparatus adapted to deflect in response to wave action.

The pumping chamber 901 is defined by a housing 905 into which the piston 903 extends, and a sheath 907 surrounding that portion of the piston 903 extending into the housing 905. The sheath 907 comprises a membrane of elastomeric material. The housing 905 comprises a cylindrical sidewall 911 and an end wall 913 at one end of the cylindrical sidewall 911. The other end of the cylindrical sidewall 911 is closed by a base 915.

The end wall 913 has an opening 917 through which the piston 903 extends.

The sheath 907 is mounted on the end wall 913 and extends and contracts with movement of the piston with respect to the housing 905, thus providing a working surface 908 which undergoes movement during operation of the pump. The sheath 907 defines an impermeable boundary between the pumping chamber 901 and the piston 903.

The boundary defined by the sheath 907 extends and contracts with corresponding movement of the piston 903 with respect to the housing 905. In this way, the pumping chamber 901 undergoes volume reduction and volume expansion with extension and contraction of the sheath 907 under the influence of the piston 903. In other words, insertion of the piston 903 further into the housing 905 causes stretching of the elastomeric sheath 907 and consequent volume reduction of the chamber 901. Correspondingly, retraction of the piston 903 allows the stretched elastomeric sheath 907 to contract, so increasing the volume of the working chamber 901.

The sheath 907 incorporates an integral gland 919 which is disposed around the piston 903 at the location where it passes through the opening 917 in the end wall 913. The gland 919 provides a fluid seal between the piston 903 and the end wall 913, as well as providing a mechanism for mounting the sheath in position within the housing 905.

The pumping chamber 901 incorporates an inlet 921 fitted with a non-return valve 923, and an outlet 925 fitted with a non-return valve 927. With this arrangement, the inlet valve 923 is adapted to open upon volume expansion of the pumping chamber 901 to permit intake of fluid and is adapted to close upon volume reduction of the pumping chamber. The outlet valve 927 is adapted to close upon volume expansion of the pumping chamber and to open during volume reduction, but only after fluid contained within the pumping chamber attains the prescribed pressure. In this way, fluid is discharged from the pumping chamber at a higher pressure than the intake pressure.

A particular advantage of the pump 900 is that the operating pressure can be large because the membrane material constituting the sheath 907 is always supported against fluid pressure by the piston itself. This feature, together with the fact that the membrane providing the sheath 907 has dimensional stability in that in cannot bulge, has the benefit that there is unlikely to be a need for additional reinforcing within the membrane.

The diameter of the piston 903 can be set to create a desired delivery pressure within the pumping chamber 901. Further, the size of the piston 903 and the pumping chamber 901 can be set to provide a given stroke volume.

The sheath 907 may have a cross-sectional thickness that varies according to the local maximum extension and the membrane stress. Suitable elastomer materials may include blends of natural rubber and blends of synthetic neoprene polymer.

A means of lubrication can be provided between the surface of the piston 903 and the surface of the sheath 907 in contact with the piston. For this purpose, the surface of the sheath 907 in contact with the piston 903 may be contoured to create voids where lubricant may accumulate during certain stages of the piston stroke. The accumulation of lubricant ensures that there is sufficient lubrication available to allow the sheath to easily slide with respect to the piston.

A further feature of the pump 900 is that it can tolerate a degree of axial tilt of the piston 903, as illustrated in FIG. 52. The axial tilt of the piston 903 is accommodated by the gland 919 and is not detrimental to fluid sealing within the pump. The feature of axial tilt makes the pump 900 particularly advantageous for use with wave energy capturing apparatus according to the embodiments described, as the tilt tolerance inherent in the pump accommodates tilting of the plates during their movement in response to wave activity, as previously described.

Because of the elastomeric construction of the moving working surface, the pump 900 avoids problems encountered by pumps of the type having a plunger reciprocating in a piston in a corrosive environment.

From the foregoing, it is evident that the present embodiments each provide a simple yet highly effective arrangement for harnessing ocean wave energy and converting the harness energy to pressurized seawater. As the apparatus rests in a submerged condition on the seabed, it creates minimal environmental impact. The operating components within the apparatus are mechanical and very simple in operation, allowing low maintenance and long life.

The apparatus thus addresses the concerns arising through many prior art devices firstly by moving all of the complex energy conversion technology on shore and secondly by reticulating energy as high-pressure seawater through proven, low-loss piping technology.

Improvements and modifications may be incorporated without departing from the scope of the invention.

Throughout the specification, unless the context requires otherwise, the word “comprise” or variations such as “comprises” or “comprising”, will be understood to imply the inclusion of a stated integer or group of integers but not the exclusion of any other integer or group of integers.

1. Apparatus for capturing wave energy in a body of water, the apparatus comprising a body structure having a portion thereof adapted to deflect in response to wave action, a pump defining a pumping chamber adapted to undergo expansion and contraction in response to deflection of the portion of the body structure, the pumping chamber having an inlet communicating with a fluid source and an outlet, whereby fluid from the fluid source is drawn into the pumping chamber upon volume expansion thereof from the pumping chamber and is discharged through the outlet upon volume reduction thereof through the outlet.

2. Apparatus according to claim 1 wherein the portion of the body structure adapted to deflect in response to wave action comprises a flexible diaphragm exposed to a body of water incorporating wave action.

3. Apparatus according to claim 2 wherein the diaphragm comprises a substantially rigid portion and a flexible portion.

4. Apparatus according to claim 3 wherein the flexible portion surrounds the rigid portion.

5. Apparatus according to claim 3 wherein the pump is operably connected to the rigid portion.

6. Apparatus according to claim 3, wherein the flexible portion comprises a flexible membrane on which the rigid portion is mounted.

7. Apparatus according to claim 3 wherein there are a plurality of said rigid portions adapted for articulation one with respect to another to define an articulated structure.

8. Apparatus according to claim 7 wherein the rigid portions are disposed in a concatenate relationship extending in the direction of wave travel.

9. Apparatus according to claim 8 wherein the rigid portions are spaced apart in the concatenate relationship to permit angular movement therebetween.

10. Apparatus according to claim 9 wherein the rigid portions are mounted on the flexible portion, whereby the flexible portion provides a connection between adjacent rigid portions.

11. Apparatus according to claim 5 wherein each rigid portion has a respective pump operably connected thereto.

12. Apparatus according to claim 2 wherein the body structure comprises a hollow structure having an upper end closed by the diaphragm.

13. Apparatus according to claim 12 wherein the body structure includes a chamber which is disposed below the flexible diaphragm and which is adapted to contain a compressible fluid such as air.

14. Apparatus according to claim 13 wherein the chamber is adapted to undergo volume expansion and volume reduction upon deflection of the diaphragm, with the compressible fluid contained within the fluid chamber being progressively compressed to yieldingly resist movement of the diaphragm in an inward direction corresponding to volume reduction of the chamber in response to wave pressure and to urge the diaphragm in the opposite direction upon abatement of the wave pressure.

15. Apparatus according to claim 13 wherein the volume of the chamber remains generally constant, the compressible fluid in the chamber being re-distributed within the chamber in response to deflection of the diaphragm without a substantial change in the volume and pressure thereof.

16. Apparatus according to claim 1 wherein the body structure includes a plurality of chambers interconnected for fluid communication therebetween and containing a compressible fluid such as air, the chambers being disposed in a series substantially aligned with the direction of wave travel, each chamber being disposed beneath a respective flexible diaphragm, the arrangement being that the diaphragms deflect in sequence in response to wave activity, with the fluid being re-distributed within the chambers to exert a restoring force on the diaphragms.

17. Apparatus according to claim 1 further comprising a valve system associated with the inlet and outlet of the or each pumping chamber, the valve system includes an inlet valve adapted to open upon volume expansion of the pumping chamber and adapted to close upon volume reduction of the pumping chamber, the valve system further includes an outlet valve associated with the outlet, the outlet valve being adapted to close upon volume expansion of the pumping chamber and to open during volume reduction only after fluid contained within the pumping chamber thereof attains a prescribed pressure.

18. Apparatus according to claim 1 further comprising means for selectively blocking operation of any one or more of the pumping chambers.

19. Apparatus according to claim 1 wherein the pumping chamber has an elastomeric wall adapted to undergo extension and contraction corresponding to a volume change of the pumping chamber.

20. Apparatus according to claim 19 wherein the pump comprises a bellows structure constructed at least in part of elastomeric material.

21. Apparatus according to claim 20 wherein the bellows structure is configured as a bellows column supporting the diaphragm.

22. Apparatus according to claim 20 wherein the bellows structure comprises a plurality of annular discs formed of elastomeric material, the annular discs being assembled in side-by-side relationship concentrically on a common axis, the annular discs (apart from the two endmost discs) each being formed integrally with or connected to an adjacent disc on one side thereof at the radially inner ends thereof and being formed integrally with or connected to an adjacent disc on the other side thereof at the radially outer ends thereof.

23. Apparatus according to claim 20, further comprising stabilisation means for laterally stabilising each bellows structure.

24. Apparatus according to claim 19 wherein the elastomeric wall comprises an elastomeric sheath cooperating with a piston, whereby reciprocating movement of the piston causes expansion and contraction of the elastomeric sheath, expansion of the elastomeric sheath corresponding to a volume reduction of the pumping chamber and contraction of the elastomeric sheath corresponding to a volume expansion of the pumping chamber.

25. Apparatus according to claim 24 wherein the elastomeric sheath is supported on a wall of a hollow housing, whereby the elastomeric sheath is accommodated within the interior of the hollow housing and wherein the pumping chamber is defined between the elastomeric sheath and the hollow housing.

26. Apparatus according to claim 25 wherein the piston extends through said wall of the hollow housing such that the elastomeric sheath is received thereon.

27. Apparatus according to claim 1 further comprising means for selectively displacing said portion to compensate for tidal conditions.

28. Apparatus according to claim 1 further comprising damper means for progressively damping inward excursions of said portion in heavy sea conditions.

29. Apparatus according to claim 1 further comprising a holding chamber adapted to undergo volume expansion and contraction in response to deflection of said portion, the holding chamber being in fluid communication with the body of water to receive water therefrom upon volume expansion of the holding chamber, the inlet of the pumping chamber communicating with the holding chamber to receive water therefrom, whereby water from the holding chamber is drawn into the pumping chamber upon volume expansion thereof and is discharged through the outlet in a pressurised condition upon volume reduction of the pumping chamber, and means for applying a selectively adjustable restoring force to said portion for biasing the holding chamber into a condition corresponding to volume expansion thereof.

30. Apparatus for capturing wave energy in a body of water, the apparatus comprising a body structure having a portion thereof adapted to move in response to wave action, a pump defining a pumping chamber adapted to undergo volume expansion and volume reduction in response to movement of the portion of the body structure, the pumping chamber having an inlet communicating with a fluid source and an outlet whereby fluid from the fluid source is drawn into the pumping chamber upon volume expansion thereof through the inlet and discharged from the pumping chamber upon volume contraction thereof through the outlet, the pumping chamber being operatively connected to said portion, the pumping chamber having an elastomeric wall adapted to undergo extension and contraction corresponding to a volume change of the pumping chamber.

31. Apparatus for capturing wave energy in a body of water, the apparatus comprising a body structure having a portion thereof adapted to deflect in response to wave action, a holding chamber adapted to undergo volume expansion and contraction in response to deflection of said portion, the holding chamber being in fluid communication with the body of water to receive water therefrom upon volume expansion of the holding chamber, a pumping chamber adapted to undergo expansion and contraction in response to deflection of the portion of the body structure, the pumping chamber having an inlet communicating with the holding chamber to receive water therefrom and an outlet, whereby water from the holding chamber is drawn into the pumping chamber upon volume expansion thereof and is discharged through the outlet in a pressurised condition upon volume reduction of the pumping chamber, and means for applying a selectively adjustable restoring force to said portion for biasing the holding chamber into a condition corresponding to volume expansion thereof.

32. Apparatus for capturing wave energy in a body of water, the apparatus comprising a body structure having a flexible diaphragm adapted to deflect in response to wave action, a pump defining a pumping chamber adapted to undergo expansion and contraction in response to deflection of the portion of the body structure, the flexible diaphragm comprising a flexible portion and a rigid portion, the pump being operably connected to the rigid portion.

33. A wave energy capturing system comprising an array of units extending transversely of the wave direction in a spaced apart relation, each unit comprising apparatus according to claim 1.
